(19) United States
(12) Patent Application Publication
(10) Pub. No.: US 2026/0204061 A1
(43) Pub. Date: Jul. 16, 2026

(54) IMAGING DEVICE, DATA PROCESSING METHOD, AND RECORDING MEDIUM

(71) Applicant: Sony Semiconductor Solutions Corporation, Kanagawa (JP)

(72) Inventors: Kohei Matsuda, Kanagawa (JP); Katsuhiko Hanzawa, Kanagawa (JP); Masaki Sakakibara, Kanagawa (JP); Akihiko Kato, Tokyo (JP)

(21) Appl. No.: 19/140,180

(22) PCT Filed: Jan. 18, 2024
(86) PCT No.: PCT/JP2024/001199

§ 371 Date: Jun. 17, 2025

(30) Foreign Application Priority Data
Feb. 3, 2023 (JP) 2023-015027

(51) Int. Cl. G06V 10/94; G06V 10/774; G06V 10/82; H04N 23/80

(52) U.S. Cl. CPC G06V 10/955; G06V 10/774; G06V 10/82; H04N 23/80

(57) ABSTRACT

Imaging devices, data processing methods, and recording media configured for enhanced information security of an imaging device equipped with a processing circuit that performs inference processing are disclosed. In one example, an image is captured, inference processing is performed using the captured image as input, and training processing of an inference model used in the inference processing is performed.

### TECHNICAL FIELD

The present technology relates to an imaging device, a data processing method, and a recording medium, and more particularly to an imaging device, a data processing method, and a recording medium capable of enhancing information security of an imaging device equipped with a processing circuit that performs inference processing.

### BACKGROUND ART

Patent Documents 1 to 4 disclose technologies for performing processing such as complementary image generation and image recognition using inference processing for images captured by an imaging element within a single chip.

### CITATION LIST

### Patent Document

Patent Document 1: Japanese Patent Application Laid-Open No. 2019-004358

Patent Document 2: Japanese Patent Application Laid-Open No. 2020-039123

Patent Document 3: Japanese Patent Application Laid-Open No. 2020-182219

Patent Document 4: Japanese Patent Application Laid-Open No. 2021-064882

### SUMMARY OF THE INVENTION

### Problems to be Solved by the Invention

To address aging effects and performance enhancement of imaging elements and the like, external access to data (such as parameters) of inference processing programs is necessary, leading to risks such as program tampering and data theft.

The present technology has been made in view of such circumstances, and it is therefore an object of the present technology to enhance information security of an imaging device equipped with a processing circuit that performs inference processing.

### Solutions to Problems

According to a first aspect of the present technology, provided are an imaging device and a recording medium, the imaging device including: an imaging unit that captures an image; and a processing unit integrated into a chip along with the imaging unit, the processing unit being configured to perform inference processing using a captured image captured by the imaging unit as input, in which the processing unit performs training processing of an inference model used in the inference processing, the recording medium recording a program causing a computer to function as the processing unit.

A data processing method of the present technology includes: causing an imaging unit of a data processing device to capture an image, the data processing device including the imaging unit and a processing unit integrated into a chip along with the imaging unit; and causing the processing unit to perform inference processing using a captured image captured by the imaging unit as input and perform training processing of an inference model used in the inference processing.

In the imaging device, the data processing method, and the recording medium according to the first aspect of the present technology, an image is captured, inference processing is performed using the captured image as input, and training processing of an inference model used in the inference processing is performed.

According to a second aspect of the present technology, provided is an imaging device including: an imaging unit that captures an image; and a processing unit that performs inference processing, in which the processing unit performs the inference processing using an element characteristic value indicating a characteristic of an element as input.

In the imaging device according to the second aspect of the present technology, an image is captured, and inference processing is performed using an element characteristic value indicating a characteristic of an element as input.

### BRIEF DESCRIPTION OF DRAWINGS

FIG. 1 is a block diagram illustrating a configuration example of an embodiment of a digital camera to which the present technology is applied.

FIG. 2 is a block diagram illustrating a basic configuration example of an imaging device illustrated in FIG. 1.

FIG. 3 is a perspective view illustrating an overview of an external configuration example of the imaging device illustrated in FIG. 1.

FIG. 4 is a perspective view illustrating an overview of an external configuration example of the imaging device illustrated in FIG. 1.

FIG. 5 is a perspective view illustrating an overview of an external configuration example of the imaging device illustrated in FIG. 1.

FIG. 6 is a diagram for describing DNN processing in the imaging device.

FIG. 7 is a diagram illustrating an example of a log regarding update processing of a circuit configuration value in the DNN processing.

FIG. 8 is a block diagram illustrating a configuration example of an embodiment of an imaging device to which the present technology is applied.

FIG. 9 is a block diagram illustrating a configuration example of another embodiment of the imaging device.

FIG. 10 is a diagram illustrating a circuit configuration example as a stacked sensor of the imaging device.

FIG. 11 is a flowchart illustrating an example procedure of inference processing of an inference model that performs object detection using a captured image as input.

FIG. 12 is a flowchart illustrating an example procedure of training processing of an inference model using a captured image as input.

FIG. 13 is a diagram for describing input/output data of an inference model that feeds back a circuit configuration value using an internal element characteristic as input.

FIG. 14 is a flowchart illustrating an example procedure of inference processing of an inference model that outputs a circuit configuration value using an internal element characteristic as input.

FIG. 15 is a diagram for describing input/output data during training of an inference model that feeds back a circuit configuration value using an internal element characteristic as input.

FIG. 16 is a flowchart illustrating an example procedure of training processing of an inference model using an internal element characteristic as input.

FIG. 17 is a diagram for describing input/output data of an inference model of an inference model that performs object detection using a captured image and an internal element characteristic as input.

FIG. 18 is a flowchart illustrating an example procedure of inference processing of an inference model that performs object detection using a captured image and an internal element characteristic as input.

FIG. 19 is a diagram for describing input/output data during training of an inference model that performs image recognition using a captured image and an internal element characteristic as input.

FIG. 20 is a flowchart illustrating an example procedure of training processing of an inference model that performs image recognition using a captured image and an internal element characteristic as input.

FIG. 21 is a flowchart illustrating an example procedure of processing of determining training timing from an inference result of inference processing of detecting an object in a captured image.

FIG. 22 is a diagram illustrating an example procedure of processing of determining training timing by detecting a change in installation environment (arrangement environment).

FIG. 23 is a block diagram illustrating a configuration example of an embodiment of a computer to which the present technology is applied.

### MODE FOR CARRYING OUT THE INVENTION

Hereinafter, embodiments of the present technology will be described with reference to the drawings.

### Background of Present Technology

Numerous devices such as smartphones and surveillance cameras with the ability to perform, using machine learning technology, inference processing such as object detection and recognition processing on images captured by image sensors are being released on the market. Furthermore, as a more advanced feature, numerous proposals have been presented at academic conferences and the like regarding devices that use captured images to train the target inference model.

Training of the inference model requires more computational resources than inference processing; therefore, it is common to perform the training processing using a cloud environment separate from an image sensor while communicating with a device side.

Such a system, however, carries security risks of images being intercepted or tampered with by malicious attackers over an unsecured external communication path. As a more advanced countermeasure against such risks, there is a way to implement an AI processor on the same board to allow training processing to be completed within an edge device.

However, even the implementation on the same board as described above carries a risk of direct probing attacks targeting the wirelines on the board. To avoid such a risk, it is considered that devices serving as components are stacked on a single chip. However, such devices have complex components, making it difficult to accurately simulate imaging characteristics and device reliability in the design phase. Furthermore, for mass-produced devices, it has been found that individually tuning various element characteristics during production is practically difficult. In addition, changes in characteristics due to aging are also observed, which poses significant challenges, especially for organic sensors and the like. To address the challenges described above, it is necessary to develop a method where the chip itself can recognize its own characteristics and perform self-tuning, in order to provide consistent imaging characteristics and functionality from the time of production through long-term use.

### Overview of Present Technology

In recent years, organic films and novel non-volatile memory devices such as magnetoresistive random access memory (MRAM) have increasingly been utilized in image sensors. For such devices, compensating for variations in characteristics during production and addressing changes in characteristic during use have become challenges.

In the present technology, provided is an image sensor (imaging device) that detects a device anomaly from each element characteristic value and environment information (such as voltage, current, and temperature) acquired on a sensor device using machine learning technology, and feeds back a circuit configuration value for achieving optimum control for the target device.

The imaging device to which the present technology is applied includes a pixel unit, a sensor control circuit, an AI processing circuit, and a memory device. In the imaging device, a monitoring circuit that acquires element characteristic values is implemented on the pixel unit, the sensor control circuit, and the memory device, and an output value of the monitoring circuit is supplied to the AI processing circuit. The AI processing unit performs inference processing to detect a device anomaly, an optimum circuit configuration value, or the like from the output value of the monitoring circuit and the like.

Furthermore, the pixel unit, the sensor control circuit, the AI processing circuit, and the memory device of the imaging device can be implemented in a stacked chip. This configuration isolates communication paths within the imaging device from external access, so that security is ensured, and the risk of images being intercepted or tampered with by malicious attackers is reduced, enhancing information security.

The AI processing circuit is capable of performing the following six types of processing. Note that the training processing given herein refers to “processing of updating the coefficients of an inference model”.
(1) Inference processing on captured image
(2) Training processing using captured image
(3) Inference processing on internal element characteristic
(4) Training processing using internal element characteristic
(5) Inference processing on both captured image and internal element characteristic
(6) Training processing using both captured image and internal element characteristic

### <<Configuration Example of Digital Camera to Which Present Technology is Applied>>

### <Embodiment of Digital Camera to Which Present Technology is Applied>

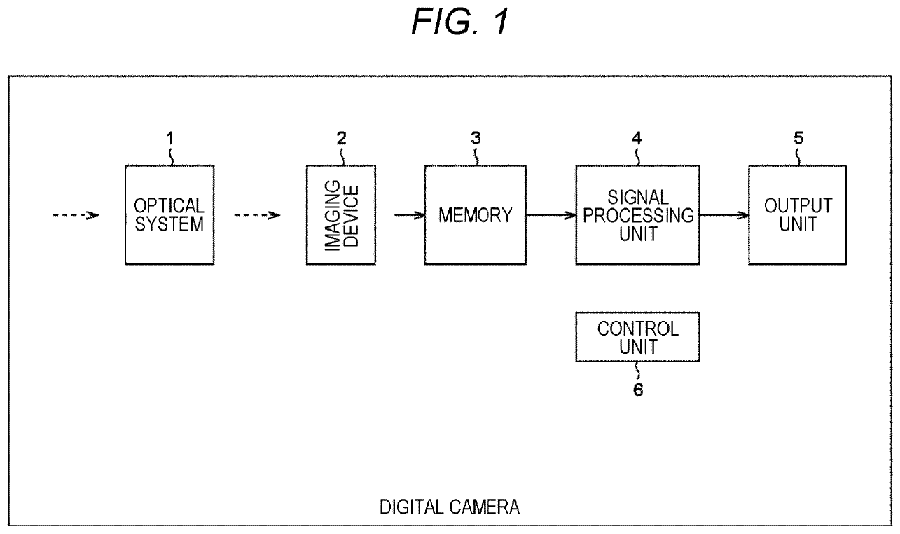

FIG. 1 is a block diagram illustrating a configuration example of an embodiment of a digital camera to which the present technology is applied. Note that the digital camera is capable of capturing both still images and moving images. In FIG. 1, the digital camera includes an optical system 1, an imaging device 2, a memory 3, a signal processing unit 4, an output unit 5, and a control unit 6.

The optical system 1 includes, for example, a zoom lens, a focus lens, a diaphragm, and the like (not illustrated), and causes light from the outside to enter the imaging device 2.

The imaging device 2 is, for example, a single-chip Complementary metal oxide semiconductor (CMOS) image sensor, receives incident light through the optical system 1, performs photoelectric conversion, and outputs image data corresponding to the incident light through the optical system 1.

Furthermore, the imaging device 2 performs, for example, artificial intelligence (AI) processing such as recognition processing of recognizing a predetermined recognition target and other signal processing using image data and the like, and outputs the signal processing result of the signal processing.

The memory 3 temporarily stores the image data and the like output from the imaging device 2.

The signal processing unit 4 performs, as necessary, processing such as noise removal and white balance adjustment as camera signal processing using the image data stored in the memory 3, and supplies the processed image data to the output unit 5. Note that the processing performed by the memory 3 and the signal processing unit 4 may be partially or entirely performed by the memory and signal processing unit of the imaging device 2.

The output unit 5 outputs the image data received from the signal processing unit 4 or the signal processing result stored in the memory 3. That is, the output unit 5 including a display (not illustrated), such as a liquid crystal display, displays an image corresponding to the image data received from the signal processing unit 4 as a so-called through image.

Furthermore, the output unit 5 including a driver (not illustrated) that drives a recording medium, such a semiconductor memory, a magnetic disk, or an optical disc, records the image data received from the signal processing unit 4 or the signal processing result stored in the memory onto the recording medium.

Moreover, the output unit 5 functions as, for example, an interface (I/F) that exchanges data with an external device, and transmits the image data received from the signal processing unit 4, the image data recorded on the recording medium, or the like to the external device.

The control unit 6 controls each block of the digital camera in accordance with user operation or the like.

In the digital camera configured as described above, the imaging device 2 captures an image. That is, the imaging device 2 receives incident light through the optical system 1, performs photoelectric conversion to acquire image data corresponding to the incident light, and outputs the image data.

The image data output from the imaging device 2 is supplied to and stored into the memory 3. The image data stored in the memory 3 is subjected to the camera signal processing by the signal processing unit 4, and the resultant image data is supplied to the output unit 5 and then output.

Furthermore, the imaging device 2 performs signal processing using a captured image (data) and the like, and outputs the signal processing result of the signal processing. The signal processing result output from the imaging device 2 is stored into the memory 3, for example.

In the imaging device 2, the captured image itself and the signal processing result of the signal processing using the image and the like are selectively output.

### <Basic Configuration Example of Imaging Device 2>

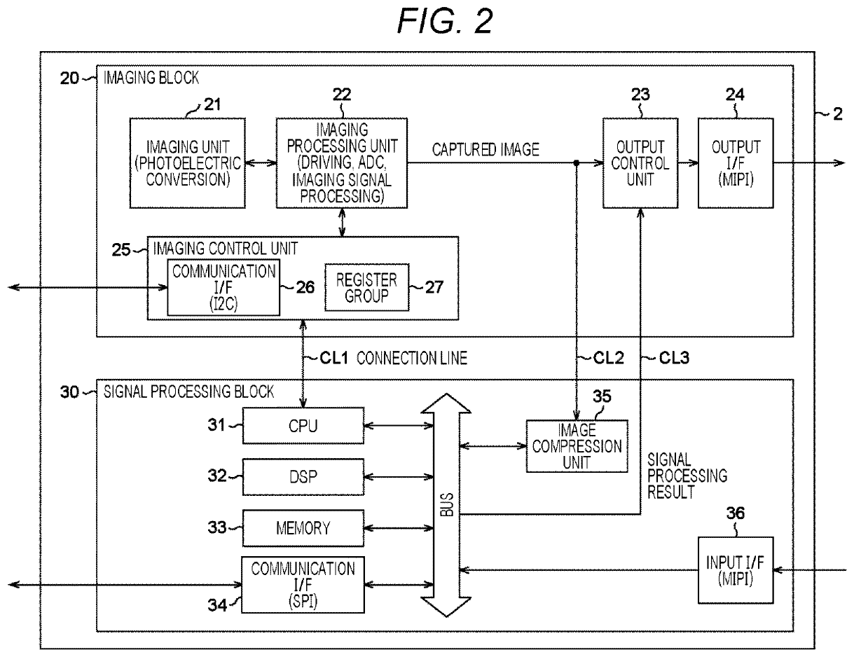

FIG. 2 is a block diagram illustrating a basic configuration example of the imaging device 2 illustrated in FIG. 1. In FIG. 2, the imaging device 2 includes an imaging block 20 and a signal processing block 30. The imaging block 20 and the signal processing block 30 are electrically connected through connection lines (internal buses) CL1, CL2, and CL3.

The imaging block 20 includes an imaging unit 21, an imaging processing unit 22, an output control unit. 23, an output interface (I/F) 24, and an imaging control unit 25, and captures an image.

The imaging unit 21 includes a plurality of pixels arranged two-dimensionally. The imaging unit 21 is driven by the imaging processing unit 22 to capture an image. That is, light through the optical system 1 (FIG. 1) impinges on the imaging unit 21. The imaging unit 21 receives the incident light through the optical system 1, performs photoelectric conversion, and outputs an analog image signal corresponding to the incident light. Note that the size of the image (signal) output by the imaging unit 21 can be selected from a plurality of sizes such as 12 megapixels (3968×2976 pixels), a video graphics array (VGA) size (640×480 pixels), and the like, for example.

Furthermore, for the image output by the imaging unit 21, it is possible to select either an RGB (red, green, blue) color image or a monochrome image based solely on luminance, for example. These selections can be made as a type of imaging mode setting.

Under the control of the imaging control unit 25, the imaging processing unit 22 performs imaging processing related to image capturing in the imaging unit 21, such as driving of the imaging unit 21, analog to digital (AD) conversion of the analog image signal output. from the imaging unit 21, or imaging signal processing.

Here, examples of the imaging signal processing include processing of determining brightness for each predetermined small region of the image output from the imaging unit 21 by calculating the average of pixel values for each small region, processing of converting the image output from the imaging unit 21 into a high dynamic range (HDR) image, defect correction, development, and the like.

The imaging processing unit 22 outputs a digital image signal (for example, an image with 12 megapixels or VGA size) obtained by AD conversion or the like of the analog image signal output from the imaging unit 21 as a captured image. The captured image output from the imaging processing unit 22 is supplied to both the output control unit 23 and an image compression unit 35 of the signal processing block 30 via the connection line CL2.

The captured image is supplied from the imaging processing unit 22 to the output control unit 23, and additionally, the signal processing result of signal processing using the captured image and the like is supplied from the signal processing block 30 to the output control unit 23 via the connection line CL3.

The output control unit 23 performs output control to cause the (single) output I/F 24 to selectively output the captured image received from the imaging processing unit 22 or the signal processing result received from the signal processing block 30 to the external unit (such as the memory 3 illustrated in FIG. 1). That is, the output control unit 23 selects the captured image received from the imaging processing unit 22 or the signal processing result received from the signal processing block 30, and supplies the selection result to the output I/F 24.

The output I/F 24 outputs the captured image and the signal processing result supplied from the output control unit 23 to the external unit. For example, a relatively high-speed parallel I/F such as a mobile industry processor interface (MIPI) (registered trademark) can be adopted as the output. I/F 24. The output I/F 24 outputs the captured image received from the imaging processing unit 22 or the signal processing result received from the signal processing block 30 to the external unit under the output control of the output control unit 23. Therefore, for example, in a case where the external unit requires only the signal processing result received from the signal processing block 30, without needing the captured image, only the signal processing result can be output, enabling a reduction in the amount of data output from the output I/F 24 to the external unit.

Furthermore, the signal processing block 30 performs signal processing to obtain the signal processing result required by the external unit, and the signal processing result is output from the output I/F 24, which eliminates the need for the external unit to perform signal processing, thereby reducing the load on the external block.

The imaging control unit 25 includes a communication I/F 26 and a register group 27. The communication I/F 26 is, for example, a first communication I/F serving as a serial communication I/F such as an inter-integrated circuit (I2C), and exchanges, with the external unit (such as the control unit 6 illustrated in FIG. 1), necessary information such as information to be read from and written to the register group 27.

The register group 27 includes a plurality of registers and stores imaging information related to the image capturing performed in the imaging unit 21 and other various types of information. For example, the register group 27 stores imaging information received from the external unit via the communication I/F 26 and the result of the imaging signal processing performed in the imaging processing unit 22 (for example, brightness for each small region of the captured image).

Examples of the imaging information stored in the register group 27 include (information indicating) ISO sensitivity (analog gain during AD conversion in the imaging processing unit 22), exposure time (shutter speed), frame rate, focus, imaging mode, cutout range, and the like.

The imaging mode includes, for example, a manual mode in which the exposure time, the frame rate, and the like are manually set, and an automatic mode in which the exposure time, the frame rate, and the like are automatically set on the basis of the scene. The automatic mode includes modes based on various imaging Scenes such as a night scene and a human portrait.

Furthermore, the cutout range indicates a range to be cut out from the image output from the imaging unit 21 in a case where a part of the image output from the imaging unit 21 is cut out and output as a captured image in the imaging processing unit 22. Specifying the cutout range enables only an area containing a person to be cut out from the image output from the imaging unit 21, for example. Note that the image cutout includes, in addition to the method of cutting out from the image output from the imaging unit. 21, a method of reading only an image (signal) in the cutout range from the imaging unit 21.

The imaging control unit 25 controls the image capturing in the imaging unit 21 by controlling the imaging processing unit 22 in accordance with the imaging information stored in the register group 27. Note that the register group 27 can store not only the imaging information and the result of the imaging signal processing performed in the imaging processing unit 22, but also output control information regarding the output control of the output control unit 23. The output control unit 23 can perform the output control of selectively outputting the captured image and the signal processing result in accordance with the output control information stored in the register group 27.

Furthermore, in the imaging device 2, the imaging control unit 25 and a central processing unit (CPU) 31 of the signal processing block 30 are connected via the connection line CL1, and the CPU 31 can read and write information from and to the register group 27 via the connection line CL1. That is, in the imaging device 2, reading and writing of information from and to the register group 27 can be performed not only by the communication I/F 26 but also by the CPU 31.

The signal processing block 30 includes the CPU 31, a digital signal processor (DSP) 32, a memory 33, a communication I/F 34, the image compression unit 35, and an input I/F 36, and performs predetermined signal processing using the captured image or the like obtained by the imaging block 10. The CPU 31 to the input I/F 36 constituting the signal processing block 30 are interconnected via a bus, and can exchange information as necessary.

The CPU 31 executes a program stored in the memory 33 to perform the control of the signal processing block 30, the reading and writing of information via the connection line CL1 from and to the register group 27 of the imaging control unit 25, and other various types of processing. For example, by executing the program, the CPU 31 functions as an imaging information calculation unit that calculates imaging information using a signal processing result obtained by signal processing performed in the DSP 32, and can feed back new imaging information calculated using the signal processing result to the register group 27 of the imaging control unit 25 via the connection line CL1 to be stored into the register group 27. Therefore, the CPU 31 can control, as a result, the imaging in the imaging unit 21 and the imaging signal processing in the imaging processing unit 22 in accordance with the signal processing result of the captured image.

Furthermore, the imaging information stored in the register group 27 by the CPU 31 can be provided (output) to the external unit from the communication I/F 26. For example, the focus information in the imaging information stored in the register group 27 can be provided from the communication I/F 26 to a focus driver (not illustrated) that controls the focus.

By executing the program stored in the memory 33, the DSP 32 functions as a signal processing unit that performs signal processing using the captured image supplied from the imaging processing unit 22 to the signal processing block 30 via the connection line CL2 and information received by the input I/F 36 from the external unit.

The memory 33 includes a static random access memory (SRAM), a dynamic RAM (DRAM), or the like, and stores data or the like necessary for processing by the signal processing block 30. For example, the memory 33 stores a program received from the external unit via the communication I/F 34, a captured image compressed by the image compression unit 35 and used in the signal processing in the DSP 32, the signal processing result of the signal processing performed in the DSP 32, information received by the input I/F 36, or the like.

The communication I/F 34 is, for example, a second communication I/F serving as a serial communication I/F such as a serial peripheral interface (SPI), and exchanges, with the external unit (such as the memory 3 or the control unit 6 illustrated in FIG. 1), necessary information such as the program executed by the CPU 31 or the DSP 32. For example, the communication I/F 34 downloads the program to be executed by the CPU 31 or the DSP 32 from the external unit, supplies the program to the memory 33 to be stored into the memory 33. Therefore, the program downloaded by the communication I/F 34 enables the CPU 31 or the DSP 32 to perform various types of processing.

Note that the communication I/F 34 can exchange not only programs but also any desired data with the external unit. For example, the communication I/F 34 can output the signal processing result obtained by the signal processing performed in the DSP 32 to the external unit. Furthermore, the communication I/F 34 outputs information based on an instruction of the CPU 31 to an external device, so that the external device can be controlled in accordance with the instruction of the CPU 31. Here, the signal processing result obtained by the signal processing performed in the DSP 32 can be output to the external unit via the communication I/F 34 and also written to the register group 27 of the imaging control unit 25 by the CPU 31. The signal processing result written to the register group 27 can be output via the communication I/F 26 to the external unit. This similarly applies to the processing result of the processing performed by the CPU 31.

The captured image is supplied from the imaging processing unit 22 to the image compression unit 35 via the connection line CL2. The image compression unit 35 performs compression processing for compressing the captured image to generate a compressed image with a smaller data size than the captured image. The compressed image generated by the image compression unit 35 is supplied to the memory 33 via the bus to be stored into the memory 33.

Here, the signal processing in the DSP 32 can be performed using not only the captured image itself but also the compressed image generated from the captured image by the image compression unit 35. Since the compressed image is smaller in data size than the captured image, it is possible to reduce the load of the signal processing in the DSP 32 and to save the storage capacity of the memory 33 that stores the compressed image.

As the compression processing in the image compression unit 35, for example, scale-down for converting the captured image of 12 megapixels (3968×2976 pixels) into a VGA-sized image can be performed. Furthermore, in a case where the signal processing in the DSP 32 is performed on luminance and the captured image is an RGB image, YUV conversion for converting the RGB image into, for example, a YUV image can be performed as the compression processing. Note that the image compression unit 35 can be implemented by software or can be implemented by dedicated hardware. Note that the captured image supplied from the imaging processing unit 22 via the connection line CL2 can be stored into the memory 33 as it is without undergoing the compression processing in the image compression unit 35. Hereinafter, even a captured image that has undergone the compression processing in the image compression unit 35 is simply referred to as a captured image without being distinguished from an uncompressed captured image.

The input I/F 36 is an I/F that receives information from the external unit. The input I/F 36 receives, for example, the output of an external sensor (external sensor output) from the external sensor, and supplies the output to the memory 33 via the bus to be stored into the memory 33.

For example, similar to the output I/F 24, a parallel I/F such as a mobile industry processor interface (MIPI) (registered trademark) can be adopted as the input I/F 36. Furthermore, as the external sensor, for example, a ranging sensor that senses information regarding distance can be adopted, and moreover, as the external sensor, for example, an image sensor that senses light and outputs an image corresponding to the light, that is, an image sensor different from the imaging device 2 can be adopted.

The DSP 32 can perform the signal processing using not only (the compressed image generated from) the captured image, but also the external sensor output received by the input I/F 36 from the external sensor as described above and stored into the memory 33.

In the single-chip imaging device 2 configured as described above, the signal processing using (the compressed image generated from) the captured image captured by the imaging unit 21 is performed by the DSP 32, and the signal processing result of the signal processing and the captured image are selectively output from the output I/F 24. It is therefore possible to downsize the imaging device that outputs information needed by the user.

Note that, in the present technology, the DSP 32 performs artificial intelligence (AI) processing on the basis of the captured image and an element characteristic value to be described later. The AI processing is processing for artificially implementing human-like intelligence on a computer or the like, and includes, for example, inference processing (inference processing using a deep neural network (DNN) algorithm) performed by an inference model (machine learning model) with a structure based on a neural network (NN), particularly a DNN, in machine learning technology. In the description of the present technology, it is assumed that inference processing using a DNN inference model is performed as the AI processing. Furthermore, the configuration of the signal processing block 30 is not limited to the configuration illustrated in FIG. 2, and the AI processing is not limited to being performed by the DSP 32. Therefore, a component that performs the AI processing (DNN processing) is not limited to the DSP 32, and it is assumed that the signal processing block 30 performs the AI processing. Moreover, in the present technology, the signal processing block 30 performs both the inference processing using the DNN inference model and processing of updating (training) parameters (weights, biases, and the like) of the inference model (referred to as update processing or training processing of the inference model). In the description of the present technology, the AI processing (DNN processing) includes AI-based inference processing (inference processing using the DNN inference model) and training processing for the inference processing (training processing of parameters (weights, biases, and the like) of the DNN inference model).

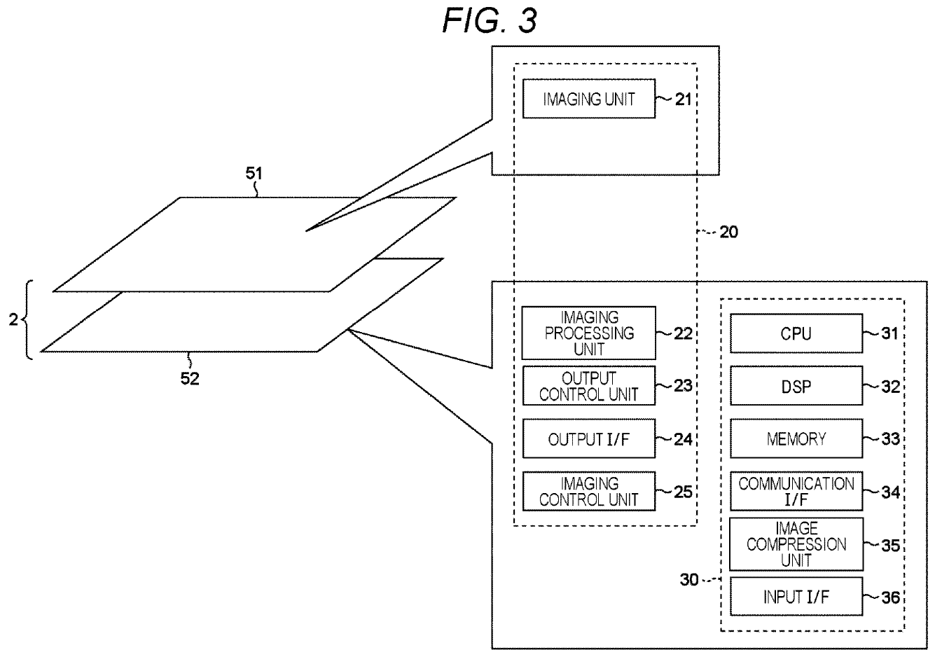

FIG. 3 is a perspective view illustrating an overview of an external configuration example of the imaging device 2 illustrated in FIG. 1.

For example, as illustrated in FIG. 3, the imaging device 2 can be configured as a single-chip semiconductor device having a stacked structure in which a plurality of dies is stacked. In FIG. 3, the imaging device 2 is a stacked chip with two dies (substrates) of dies 51 and 52 stacked to form a single chip (integrated into a single chip).

In FIG. 3, the imaging unit 21 is integrated into the upper die 51, and the imaging processing unit 22 to the imaging control unit 25 and the CPU 31 to the input I/F 36 are integrated into the lower die 52. The upper die 51 and the lower die 52 are electrically connected through, for example, a through-hole formed to pass through the die 51 and reaches the die 52, Cu-Cu bonding for directly connecting Cu wiring exposed on a lower surface side of the die 51 and Cu wiring exposed on an upper surface side of the die 52, or the like.

Here, in the imaging processing unit 22, as a method for performing AD conversion of the image signal output from the imaging unit 21, for example, a column-parallel AD method or an area AD method can be adopted.

In the column-parallel AD method, for example, an AD converter (ADC) is provided for each column of pixels that constitute the imaging unit 21 and is responsible for AD conversion of the pixel signals of the pixels in the column, so that the image signals of the pixels in the respective columns of each row are subjected to AD conversion in parallel. In a case where the column-parallel AD method is adopted, the imaging processing unit 22 that performs AD conversion using the column-parallel AD method may be partially integrated into the upper die 51.

In the area AD method, the pixels that constitute the imaging unit 21 are segmented into a plurality of blocks, and the ADC is provided for each block. Then, the ADC of each block is responsible for AD conversion of the pixel signals of the pixels of the block, so that the image signals of the pixels in the plurality of blocks are subjected to AD conversion in parallel. In the area AD method, AD conversion (including reading) of image signals can be selectively performed on necessary pixels within the imaging unit 21, using each block as the smallest unit.

Note that, if an increase in the size of the imaging device 2 is acceptable, the imaging device 2 can be configured with a single die.

Furthermore, although the two dies 51 and 52 are stacked to form the single-chip imaging device 2 in FIG. 3, the single-chip imaging device 2 can be configured with three or more stacked dies. For example, in a case where three dies are stacked to form the single-chip imaging device 2, the memory 33 illustrated in FIG. 3 can be integrated into another die.

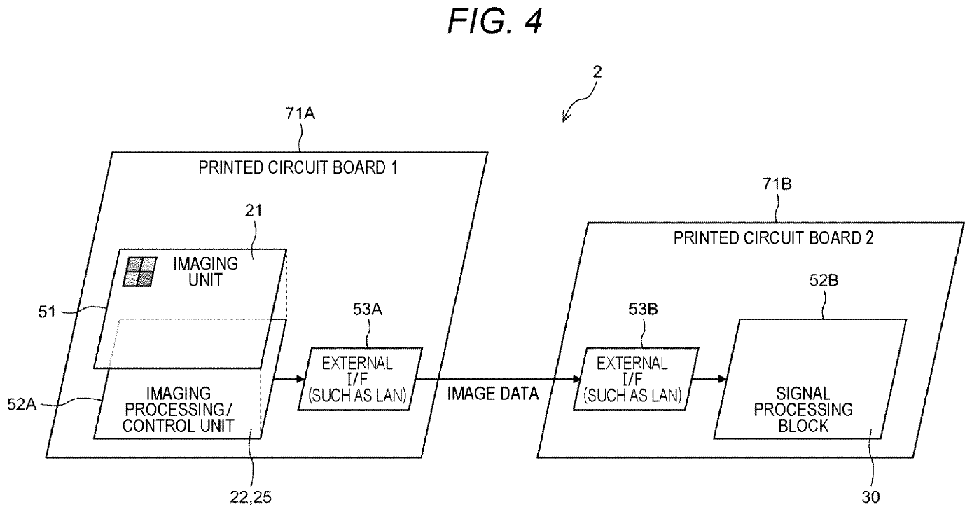

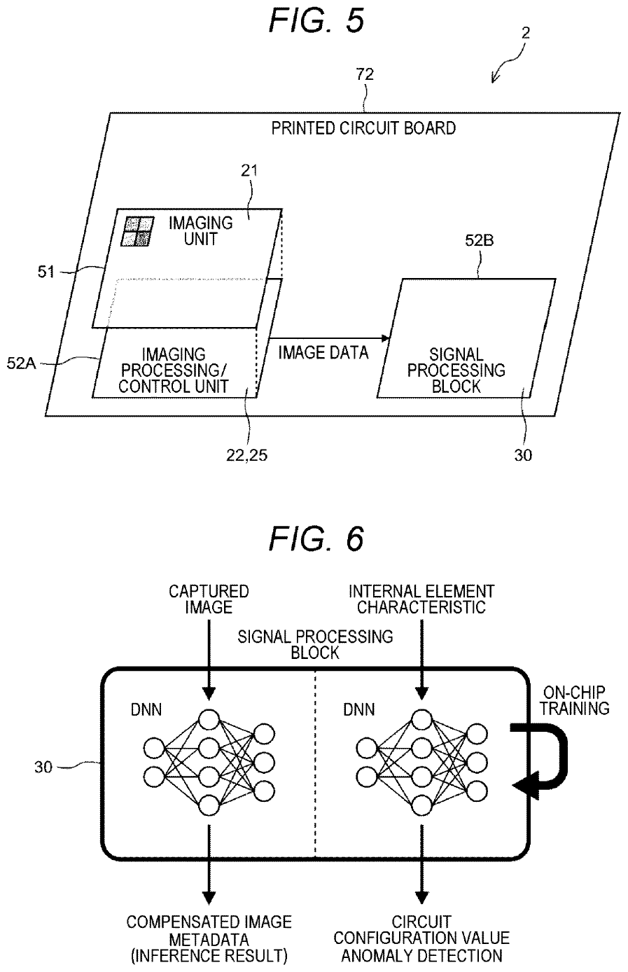

Furthermore, the imaging device 2 may be configured as illustrated in FIGS. 4 and 5. Note that, in FIGS. 4 and 5, parts common to the imaging device 2 illustrated in FIG. 3 and parts common to the imaging device 2 illustrated in FIGS. 4 and 5 are denoted by the same reference numerals, and their descriptions will be omitted where appropriate. The imaging device 2 illustrated in FIG. 4 includes two independent printed circuit boards 71A and 71B. The printed circuit board 71A is equipped with two dies 51 and 52A and an external I/F 53A. Note that the dies 51 and 52A are stacked and integrated into a single chip. Furthermore, the die 51 and the die 52A are electrically connected through Cu-Cu bonding for directly connecting Cu wiring exposed on a lower surface side of the die 51 and Cu wiring exposed on an upper surface side of the die 52A, in a manner similar to the die 51 and the die 52 illustrated in FIG. 3. The die 52A and the external I/F 53A are electrically connected through, for example, wiring printed on the printed circuit board 71A. The imaging unit 21 is integrated into the die 51 in a manner similar to the die 51 illustrated in FIG. 3, and imaging processing/control units 22 and 25, which are part of the components integrated into the die 52 illustrated in FIG. 3, are integrated into the die 52A. The imaging control/processing units 22 and 25 are components including the imaging processing unit 22 and the imaging control unit 25. The imaging processing/control units 22 and 25 supply the captured image output from the imaging processing unit 22 and information input into/output from the imaging control unit 25 to the external I/F 53A or acquire the captured image and the information from the external I/F 53A.

The printed circuit board 71B is equipped with a die 52B and an external I/F 53B. The die 52B and the external I/F 53B are electrically connected through, for example, wiring printed on the printed circuit board 71B. Components including the signal processing block 30, which are part of the components integrated into the die 52 illustrated in FIG. 5, are integrated into the die 52B. Note that the output control unit 23 and the output I/F 24 are integrated into the die 52B. Furthermore, some of the components integrated into the die 52 illustrated in FIG. 3 are integrated into the die 52A, while the other components are integrated into the die 52B, and some components are commonly integrated into both the die 52A and the die 52B. Therefore, for example, a processing unit that performs DNN processing (AI processing) that is part of the processing of the signal processing block 30 may be integrated into the die 52B, and a processing unit that performs processing other than the DNN processing may be integrated into the die 51A.

The external I/F 53A of the printed circuit board 71A and the external I/F 53B of the printed circuit board 718 are communicatively connected through, for example, a local area network (LAN). Through communication between the external I/F 53A and the external I/F 53B, various types of information such as captured images are exchanged between the imaging processing/control unit 25 of the die 52A and the signal processing block 30 of the die 52B.

The imaging device 2 illustrated in FIG. 5 includes a single printed circuit board 72. The printed circuit board 72 is equipped with two dies 51 and 52A, which correspond to the dies 51, 52A, and 52B illustrated in FIG. 4, and the external I/F 53A. Note that the dies 51 and 52A are stacked and integrated into a single chip. Furthermore, the die 51 and the die 52A are electrically connected through Cu-Cu bonding for directly connecting Cu wiring exposed on a lower surface side of the die 51 and Cu wiring exposed on an upper surface side of the die 52A, in a manner similar to the die 51 and the die 52 illustrated in FIG. 3. The imaging unit 21, the imaging processing/control units 22 and 25, and the signal processing unit lock 30 are integrated into the dies 51, 52A, and 52B, respectively, in a manner similar to the dies 51, 52A, and 52B illustrated in FIG. 4. The die 52A and the die 52B are electrically connected through, for example, wiring printed on the printed circuit board 71A. Through this wiring connection, various types of information such as captured images are exchanged between the imaging control/processing unit 25 of the die 52A and the signal processing block 30 of the die 52B.

Here, since the training of the inference model used in the DNN processing of the signal processing block 30 requires more computational resources than the inference processing with the inference model, it is typical to use a cloud environment to communicate with the imaging device 2 while performing the training processing in the cloud. Such a system, however, carries security risks of images being intercepted or tampered with by malicious attackers over an unsecured external communication path.

On the other hand, performing the training processing inside the imaging device 2 (signal processing block 30) reduces the above-described security risks. In particular, among the imaging devices 2 illustrated in FIGS. 3 to 5, the imaging device 2 illustrated in FIG. 3 carries the lowest security risk. For example, the imaging device 2 illustrated in FIG. 4 carries a risk of data such as captured images being probed during transmission between the printed circuit board 71A (external I/F 53A) and the printed circuit board 71B (external I/F 53B). The imaging device 2 illustrated in FIG. 5 contains a risk of data such as captured images being probed during transmission between the die 52A and the die 52B. The imaging device 2 illustrated in FIG. 3 has an extremely low likelihood of such a risk.

Furthermore, the imaging device 2 illustrated in FIG. 3 is advantageous for downsizing and speeding up data transmission for captured images from the imaging processing unit 22 to the output control unit 23, as compared to imaging devices 2 illustrated in FIGS. 4 and 5.

Note that, as the signal processing performed in the imaging device 2, that is, the signal processing of the DSP 32 of the signal processing block 30, for example, fusion processing, self-localization processing (simultaneously localization and mapping (SLAM) ), and the like can be adopted in addition to the DNN processing (AI processing). In the fusion processing, for example, the imaging device 2 receives, through the input I/F 36, the output of a ranging sensor such as a time of flight (ToF) sensor arranged in a predetermined positional relationship with the imaging device 2. The DSP 32 integrates the output of the ranging sensor and the captured image to derive an accurate distance through processing of removing, using the captured image, noise from the distance image obtained from the output of the ranging sensor. In the self-localization processing, for example, the imaging device 2 receives, through the input I/F 36, an image output from an image sensor arranged in a predetermined positional relationship with the imaging device 2. The DSP 32 performs self-localization using the image received through the input I/F 36 and the captured image as stereo images. In the present embodiment, it is assumed that the DNN processing is performed as the signal processing of the DSP 32.

### <<DNN Processing (AI Processing) in Imaging Device 2>>

The DNN processing in the imaging device 2 will be described with reference to FIG. 6. The DNN processing in the imaging device 2 is performed by the signal processing block 30 illustrated in FIG. 2, and a captured image received from the imaging unit 21 and an internal element characteristic (element characteristic value indicating the internal element characteristic) of the imaging device 2 received from a monitoring circuit to be described later can be input into the signal processing block 30. The signal processing block 30 can perform DNN processing as described in the following (1) to (4).
(1) DNN processing on captured image As the DNN processing in the imaging device 2, image recognition such as object detection and segmentation, generation of various types of processed images such as image compression and high-resolution enhancement (super-resolution), and the like through DNN processing (inference processing) using a machine learning technology such as a convolutional neural network (CNN), a generative adversarial network (GAN), or a Transformer technology can be performed. In this case, the input into the inference model used in the DNN processing is considered to be a captured image captured by the imaging unit 21 as illustrated in FIG. 6, and the output from the inference model is considered to be an image processed through the DNN processing (compensated image), metadata (inference result), or both. Hereinafter, the inference model used in the DNN processing is also simply referred to as an inference model.
(2) DNN processing on internal element characteristic
As the DNN processing in the imaging device 2, detection of anomalies in various elements constituting the imaging device 2, estimation of an appropriate circuit configuration value (core power supply voltage, bias voltage/current, and the like supplied to each module of the imaging device 2) to be fed back to the internal circuit of the imaging device 2, and the like can be performed. In this case, the characteristic of each element constituting the imaging device 2 (internal element characteristic) as illustrated in FIG. 6 is input into the inference model. A value (element characteristic value) indicating the internal element. characteristic can be acquired from the monitoring circuit arranged inside the imaging device 2. The output from the inference model is considered to be a circuit configuration value, (the result of) anomaly detection, or both.

### (Specific Example of Element Characteristic Value)

Here, examples of the element characteristic value input into the inference model include the following.

Note that the element characteristic value input into the inference model may include one type or a plurality of types of element characteristic values in any combination.
Signal line voltage, power supply noise, and ambient environment information (such as temperature and gyroscope) during readout of the pixel signal for each column from the pixel array unit in the imaging device 2
Signal line voltage, power supply noise, and ambient environment information (such as temperature and gyroscope) during each word readout in the memory device (memory 33)
Supply voltage and consumption current waveform for each block (specifically, power waveform and current consumption value when dynamic voltage and frequency scaling (DVFS) technology is applied as a power-saving technology)

### (Specific Example of Circuit Configuration Value)

Examples of the circuit configuration value (control parameter) output from the inference model include the following. The circuit configuration value output from the inference model may be one type or a plurality of types of circuit configuration values in any combination.
Supply power voltage supplied to the pixel array unit, negative bias voltage, load MOS current source in the source follower unit, readout pulse width, and the like
Reference voltage value for sense amplifier in a memory read circuit
Pixel driving timing (such as trigger pulse timing and rise time)

### Application Example

There is a concern about degradation of a sensor device using an organic material under strong light exposure, but it is possible to control, by monitoring the signal voltage and the like of each column during sensor readout and inputting the signal voltage and the like into the inference model, the pixel negative bias, the load MOS current amount, the readout pulse width, and the like in accordance with the current degradation state.
(3) DNN processing on captured image and internal element characteristic
As the DNN processing in the imaging device 2, image recognition, generation of a compensated image, and the like through the DNN processing can be performed, in manner similar to (1). However, unlike (1), both the captured image and the internal element characteristic are input into the inference model, and the compensated image, the metadata (inference result), or both are output from the inference model. Since not only the Captured image but also the internal element characteristic is input into the inference model, variations and changes in characteristic for each element are taken into consideration, enabling image recognition with higher accuracy and generation of a processed image.

### Application Example

During sensor readout for the pixel array unit, the current value of a load MOS transistor in each column circuit is monitored and input into the inference model, enabling the inference processing to be performed on the captured image with changes in linearity characteristics taken into consideration.
(4) Training processing (on-chip training)
As the DNN processing in the imaging device 2, in a case where any one of the above (1) to (4) is performed, training processing (update processing) of the inference model, in other words, updating parameters (such as weighting coefficients and biases) of the inference model can be performed. For example, backpropagation can be adopted as the training processing of the inference model. In this case, the captured image and the element characteristic value are stored as training data into the memory inside the imaging device 2, and the optimum parameters of the inference model are calculated using the stored training data and backpropagation. The parameters of the inference model after the training processing are updated to the calculated optimal parameters.

### <Timing of Performing Training Processing of Inference Model>

In the imaging device 2 of the present technology, timing (training timing) at which the training processing of the inference model is performed can be determined on-chip. As the method for determining the training timing, for example, the following method can be applied. Note that, in a case where training data (supervised data) such as captured images used in the training processing of the inference model are newly acquired, the training processing includes processing of acquiring (collecting) the training data, and the training timing is defined as timing when the acquisition of training data starts.

In a first determination method, in a case where the inference model outputs confidence scores for a plurality of classes as an inference result, a case where it is determined that the peak of the confidence score distribution for each class output by the inference model has decreased (a case where it is determined that the distribution does not have a significant peak and an object (class) cannot be inferred with a significant difference) such as a case where the confidence score distribution for each class does not show a peak higher than a predetermined determination value or a case where none of the classes shows a confidence score exceeding the confidence scores of the other classes by a predetermined difference is set as (determined to be) the training timing. Furthermore, the training timing may be determined in a case where a difference between the highest and second highest confidence scores among the confidence scores for each class is less than or equal to a threshold, in a case where the highest confidence score is smaller than the threshold, or the like.

In a second determination method, the training timing is set (determined) in a case where the arrangement environment of the imaging device 2 is updated (changed). Whether or not the arrangement environment of the imaging device 2 has been updated can be determined on the basis of, for example, information regarding the environment in which the imaging device 2 is arranged (such as temperature, brightness, and gravity). The information regarding the environment is detected by a sensor built in the imaging device 2 or a sensor separate from the imaging device 2, and is supplied to the imaging device 2.

In a third determination method, a case where the element characteristic value inside the imaging device 2 is determined to be abnormal, or a case where a change in the element characteristic value exceeds a predetermined threshold is set as (determined to be) the training timing.

In a fourth determination method, in the combination of the imaging device 2 and a motion detection sensor, a case where the motion detection sensor provides input into the imaging device 2 that deviates from regular movement of the object is set as (determined to be) the training timing.

Note that the training timing may be set on the basis of an external signal supplied to the imaging device 2.

<Storage and Output Mechanism for Record (log) Regarding Update Processing of Circuit Configuration Value Through DNN Processing>

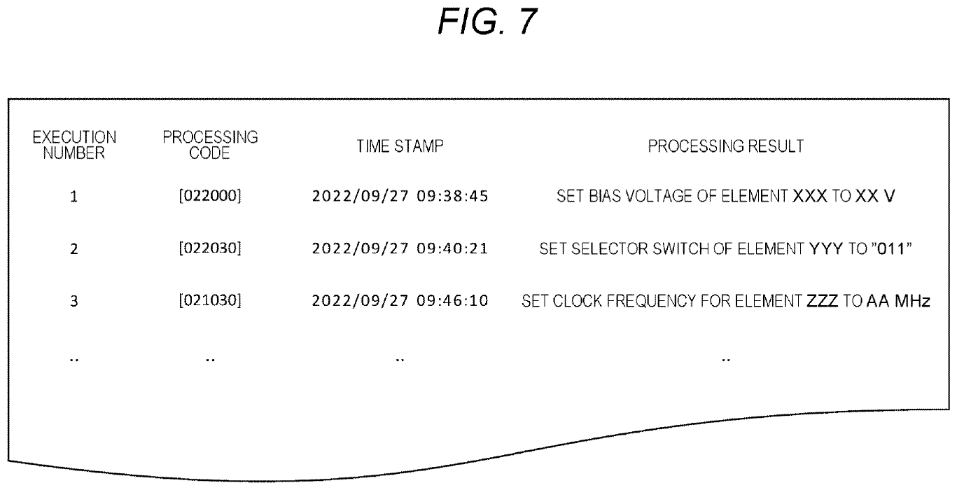

In a case where the imaging device 2 performs DNN processing of inferring an appropriate circuit configuration value for the internal circuit and feeding back the circuit configuration value to the internal circuit (update processing of the circuit configuration value), the imaging device 2 may have a mechanism (function) of storing and outputting information regarding the update processing of the circuit configuration value, that is, information indicating how the circuit configuration value has been inferred and determined, as a record (log). The log is stored into the memory 33 of the imaging device 2 when the update processing of the circuit configuration value through the DNN processing is performed, and is output to the external device in response to a request from the external device or the like. FIG. 7 is a diagram illustrating an example of a log regarding the update processing of the circuit configuration value through the DNN processing. In FIG. 7, the log information includes information such as an execution number, a processing code, a time stamp, input information (not illustrated), and a processing result. The execution number represents an order in which the update processing of the circuit configuration value is performed. The processing code represents a code assigned to each execution of the update processing of the circuit configuration value. The time stamp represents a time at which the update processing of the circuit configuration value is performed. The input information represents the internal element characteristic (element characteristic value) input into the DNN processing (inference model) when the update processing of the circuit configuration value is performed. The processing result represents a circuit configuration value updated through the update processing of the circuit configuration value, and FIG. 7 shows, as an example of the updated circuit configuration value, a configuration value of a bias voltage for the element xxx, a configuration value of a selector switch of the element yyy, and a configuration value of a clock frequency for the element zzz.

### <Label for Training Processing of Training Inference Model>

In typical inference model training processing, training processing of associating output data output from the inference model with labels (ground truth data) to be output from the inference model on the basis of input data input into the inference model, the input data being prepared in advance, and obtaining parameters of the inference model that minimize an error therebetween is performed.

In the training processing of the inference model in the imaging device 2 of the present technology, the following training method can be used in addition to the typical training method described above. For example, it is assumed that processing of modifying the circuit configuration value for the memory element (memory 33) is performed as the DNN processing. In this case, the training processing of the inference model used for inference of the circuit configuration value is performed, for example, in a state where data can be read from and written to a test cell of the memory 33 and output data serving as the ground truth can be obtained.

It is assumed that detection of anomalies in the internal elements (detection of anomalies in operation) of the imaging device 2 is performed as the DNN processing. In this case, in the training processing of the inference model used for detection of anomalies in the internal elements, training is performed using only data from normal operation defined by the user or the system. During inference, how much the data input into the inference model differs from the training data is evaluated by the inference model, and anomalies in the operation of the elements are detected on the basis of the evaluation result (see Non-Patent Document: J. Yu, et al., “FastFlow: Unsupervised Anomaly Detection and Localization via 2D Normalizing Flows, ” arXiv: 2111.07677, etc.).

It is assumed that processing using an inference model designed to primarily receive captured images as input is performed as the DNN processing. In this case, in training processing of the inference model, an unsupervised learning method that does not involve the preparation of specific ground truth labels can be used. Since many techniques have been proposed for the unsupervised learning method (for example, Non-Patent Document: T. Chen, et al., “A Simple Framework for Contrastive Learning of Visual Representations” arXiv: 2002.05709), the description will be omitted.

### <<Embodiment of Imaging Device 2 to Which the Present Technology is Applied>>

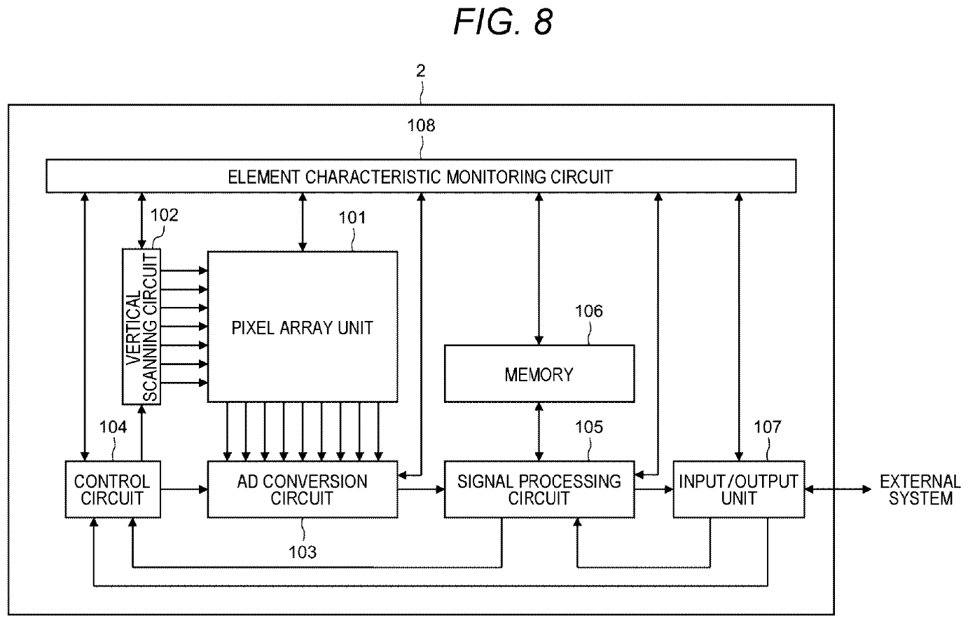

FIG. 8 is a block diagram illustrating a configuration example of an embodiment of the imaging device 2 to which the present technology is applied.

FIG. 8 illustrates components of the imaging device 2 not illustrated in FIGS. 2 to 5, and further illustrates components obtained by embodying or abstracting some components illustrated in FIGS. 2 to 5.

In FIG. 8, the imaging device 2 includes a pixel array unit 101, a vertical scanning circuit 102, an AD conversion circuit 103, a control circuit 104, a signal processing circuit 105, a memory 106, an input/output unit 107, and an element characteristic monitoring circuit 108. The pixel array unit 101 is a component serving as the imaging unit 21 illustrated in FIG. 2.

The pixel array unit 101 includes a plurality of pixel circuits arranged in a matrix in a horizontal direction (row direction) and a vertical direction (column direction). Each pixel circuit includes a photoelectric conversion element that performs photoelectric conversion on received light and a circuit that reads electric charge from the photoelectric conversion element. In the pixel array unit, the arrangement of the pixel circuits in the row direction is referred to as a line. For example, in the pixel array unit 100 with X pixel circuits per line and Y lines, a captured image (image data) of one frame can be formed by (X * Y) pixels (pixel signals). Note that the pixel array unit 101 may include a dual photodiode (PD), a ToF, an event-based vision sensor (EVS), or the like.

The vertical scanning circuit 102 is a part of the circuit in the imaging processing unit 22 of FIG. 2 that drives the imaging unit 21. Under the control of the control circuit 104, the vertical scanning circuit 102 supplies a control signal for reading pixel signals to the pixel circuits of the pixel array unit 101 for each line. The line to which the control signal is supplied is switched in the vertical direction, and the pixel signals are read from the pixel circuits for each line and transmitted to the AD conversion circuit 103.

The AD conversion circuit 103 is a circuit unit included in the imaging processing unit 22 illustrated in FIG. 2. The AD conversion circuit 103 converts the pixel signals (analog image signals) received from the pixel array unit 101 into a digital image signal through AD conversion or the like, and supplies the digital image signal to the signal processing circuit 105 as a captured image.

The control circuit 104 includes a circuit unit that performs processing of the imaging control unit 25 illustrated in FIG. 2, and controls the AD conversion circuit 103, the signal processing circuit 105, the memory 106, the input/output unit 107, and the element characteristic monitoring circuit 108. The control circuit 104 controls the image capturing in the pixel array unit 101 by controlling the vertical scanning circuit 1012, the AD conversion circuit 103, and the like.

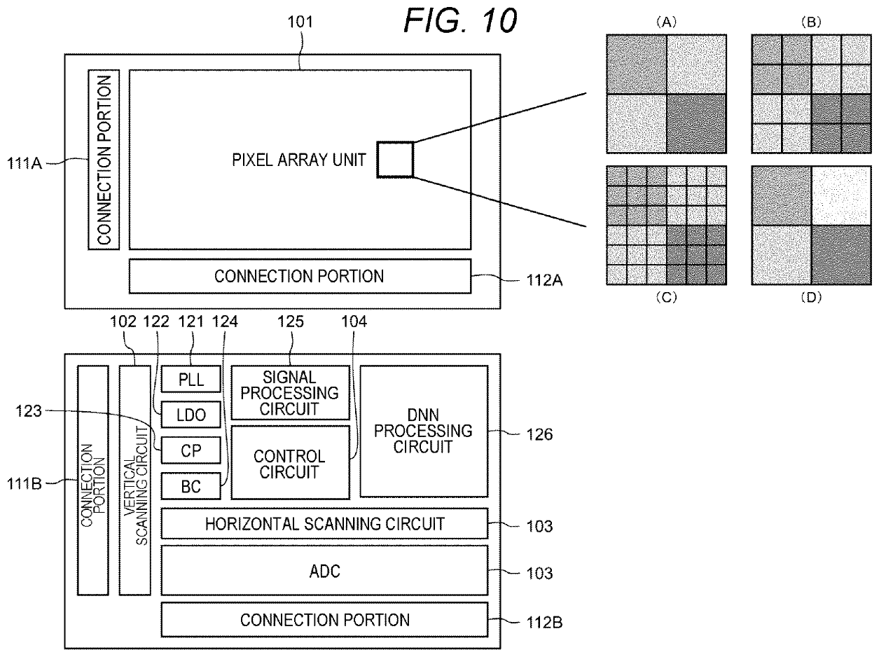

The signal processing circuit 105 is a circuit unit that performs the imaging processing in the imaging processing unit 22 illustrated in FIG. 2, the processing of the signal processing block 30, and the like. The signal processing circuit 105 includes a circuit unit (DNN processing circuit 126 illustrated in FIG. 10) that performs the above-described DNN processing (AI processing). The captured image processed by and the signal processing result of the signal processing circuit 105 are supplied to the input/output unit 107. Note that the signal processing circuit 105 may include a plurality of circuit units (for example, a plurality of processors). For example, in the configuration example of the imaging device 2 illustrated in FIG. 10 to be described later, a case where the signal processing circuit 105 includes the DNN processing circuit 126 that performs processing including the DNN processing and a signal processing circuit 125 that performs processing other than the processing in the DNN processing circuit 126 is illustrated.

The memory 106 corresponds to the memory 33 of the signal processing block 30 illustrated in FIG. 2. The memory 106 includes a volatile memory used to buffer an image, intermediate data, or the like, and a non-volatile memory used to store parameters (such as weights) and the like of the inference model used in the DNN processing.

The input/output unit 107 is a circuit unit. including the output control unit 23 and the output I/F 24 of the imaging block 20, and the input I/F 36 of the signal processing block 30 illustrated in FIG. 2. Note that the communication I/Fs 26 and 34 illustrated in FIG. 2 may be included in the input/output unit 107.

The element characteristic monitoring circuit 108 (hereinafter, referred to as a monitoring circuit 108) is a circuit unit that detects the internal element characteristic of the imaging device 2. The monitoring circuit 108 detects an element characteristic value indicating the element characteristic of each module including the pixel array unit 101 to the input/output unit 107 of the imaging device 2, and stores the element characteristic value into the memory 106. The element characteristic value detected by the monitoring circuit 108 may be supplied to the signal processing circuit 105 (DNN processing circuit 126) rather than being stored into the memory 106. The element characteristic value detected by the monitoring circuit 108 is used as input for the inference model in a case where detection of anomalies in the elements (modules) constituting the imaging device 2 or inference of an appropriate circuit configuration value to be fed back to the internal circuit of the imaging device 2 is performed in the DNN processing on the internal element characteristic of the signal processing circuit 105. Furthermore, the element characteristic value stored in the memory 106 is used in the training processing of the inference model. Note that, in a case where an anomaly in an element is detected, an anomaly detection signal indicating the detection is output from the signal processing circuit 105 (DNN processing circuit 126 illustrated in FIG. 10) to the external system or the control circuit 104.

### Other Embodiments of Imaging Device 2

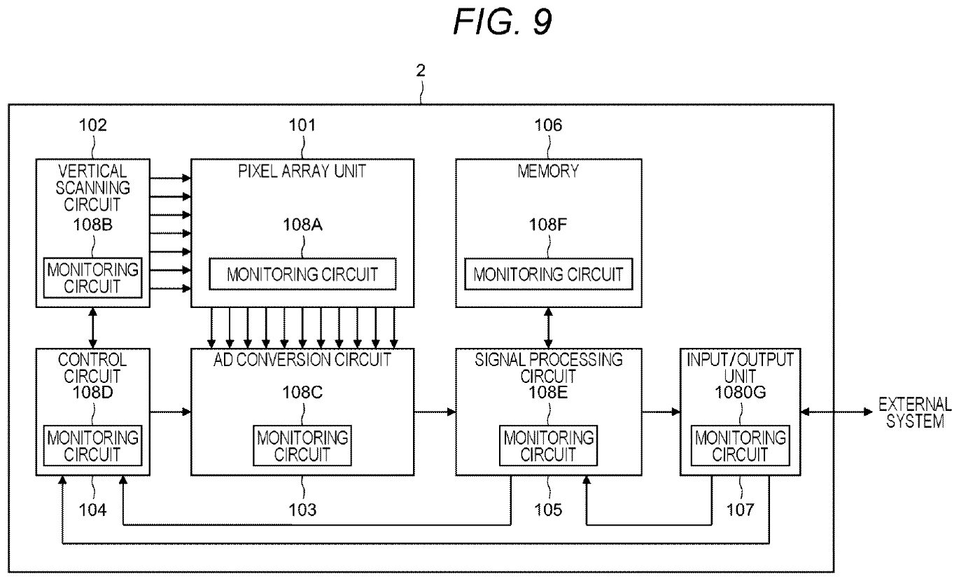

FIG. 9 is a block diagram illustrating a configuration example of another embodiment of the imaging device 2. In the drawing, parts common to the imaging device 2 illustrated in FIG. 8 are denoted by the same reference numerals, and their descriptions will be omitted where appropriate.

In FIG. 9, the imaging device 2 includes a pixel array unit 101, a vertical scanning circuit 102, an AD conversion circuit 103, a control circuit 104, a signal processing circuit 105, a memory 106, an input/output unit 107, and monitoring circuits 108A to 108G. Therefore, there is a commonality between the imaging device 2 illustrated in FIG. 9 and the imaging device 2 illustrated in FIG. 8 in that both include the pixel array unit 101, the vertical scanning circuit 102, the AD conversion circuit 103, the control circuit 104, the signal processing circuit. 105, the memory 106, and the input/output unit 107. However, there is a difference between the imaging device 2 illustrated in FIG. 9 and the imaging device 2 illustrated in FIG. 8 in that the imaging device 2 illustrated in FIG. 9 includes the monitoring circuits 108A to 108G instead of the monitoring circuit 108 of the imaging device 2 illustrated in FIG. 8.

The monitoring circuits 108A to 108G are provided in the pixel array unit 101, the vertical scanning circuit 102, the AD conversion circuit 103, the control circuit 104, the signal processing circuit 105, the memory 106, and the input/output unit 107, respectively. The monitoring circuits 108A to 108G each detect the element characteristic value indicating the characteristic of the corresponding module (component) equipped with the monitoring circuit. The element. characteristic values detected by the monitoring circuits 108A to 108G are stored into the memory 106 or supplied to the signal processing circuit 105 (DNN processing circuit 126). The element characteristic values detected by the monitoring circuits 108A to 108G are used in the DNN processing on the internal element characteristic of the signal processing circuit 105, similar to the imaging device 2 illustrated in FIG. 8. Note that the monitoring circuit 108A provided in the pixel array unit 101 may read the element characteristic value of a test element through the AD conversion circuit 103.

### Specific Example of Monitoring Circuit

As specific examples, technologies disclosed in Reference Document 1 (Japanese Patent Application Laid-Open No. 2018-101966), Reference Document 2 (Japanese Patent Application Laid-Open No. 2006-202383), Reference Document 3 (Japanese Patent Application Laid-Open No. 2021-67473), and Reference Document 4 (T. Hashida, et al., “An On-Chip Waveform Capturer and Application to Diagnosis of Power Delivery in SoC Integration,” Journal of Solid-State Circuits, vol. 46, No. 4, Apr. 2011.) can be applied to the monitoring circuit 108 illustrated in FIG. 8 and the monitoring circuits 108A to 108G illustrated in FIG. 9 (hereinafter, all are collectively referred to as a monitoring circuit 108).

For example, Reference Document 1 discloses a pixel provided around a pixel array and physically shielded by metal wiring, and the pixel can be applied to the monitoring circuit 108. The monitoring circuit 108 acquires black-level output characteristics of the pixel array as an element characteristic value. According to Reference Document 2, a method for monitoring characteristics with a configuration where a memory cell is equipped with a dummy cell is disclosed, and the method can be applied to the monitoring circuit 108.

Reference Document 3 discloses a circuit for performing highly accurate temperature measurement in a CMOS image sensor. This circuit can be applied to the monitoring circuit 108. According to Reference Document 4, a technology for acquiring voltage waveforms within a system on chip (SoC) is disclosed. This technology can be applied to the monitoring circuit 108.

### <Circuit Configuration Example as Stacked Sensor of Imaging Device 2>

FIG. 10 is a diagram illustrating a circuit configuration example as a stacked sensor of an imaging device.

Note that configuration examples of the imaging device 2 as a stacked chip are illustrated in FIGS. 3 to 5, and FIG. 10 is a diagram illustrating a circuit-level arrangement in the configuration example illustrated in FIG. 3. In FIG. 10, the imaging device 2 is configured as a single stacked chip including a stack of an upper die 51 and a lower die 52. The die 51 is a pixel chip equipped with the pixel array unit 101, and the die 52 is a circuit chip equipped with components other than the image array unit 101 of the imaging device 2. Wiring connecting between the die 51 and the die 52 is placed between connection portions 111A and 112A of the die 51 and connection portions 111B and 112B of the die 51, the connection portions 111B and 112B facing the connection portions 111A and 112A, respectively. In the pixel array unit 101 of the die 51, for example, color filters arranged in a Bayer array as illustrated in (A) to (C) in the drawing, the color filters being made up of primary colors of red (R), green (G), and blue (B), are installed on the photodetector of each pixel. (A) to (C) in the drawing illustrate color filters, that is, RGB filters arranged in a Bayer array for each pixel, for each group of four adjacent pixels, and for each group of nine adjacent pixels, respectively. Furthermore, the filter installed on the photodetector of each pixel may be a color filter of four colors as illustrated in (D) in the drawing, an IR-pass filter, a polarizing filter, a complementary color filter, or the like, and is not particularly limited.

The vertical scanning circuit 102, the AD conversion circuit 103 (denoted as ADC in the drawing), and the control circuit 104 illustrated in FIGS. 8 and 9 are integrated into the die 52. Furthermore, a horizontal scanning circuit 103, a frequency generation circuit (PLL) 121, a power supply circuit (LDO) 122, a step-up circuit (CP) 123, a bias voltage circuit (BC) 124, the signal processing circuit 125, and the DNN processing circuit 126 are integrated into the die 52. Because the horizontal scanning circuit 103 is part of the AD conversion circuit 103 illustrated in FIGS. 8 and 9, they share the same reference numeral. The signal processing circuit 125 and the DNN processing circuit 126 are included in the signal processing circuit 105 illustrated in FIGS. 8 and 9, and in the signal processing circuit 105, a processing circuit that primarily performs the DNN processing serves as the DNN processing circuit 126, and circuits other than the DNN processing circuit 126 serve as the signal processing circuit 125.

### <<Example Procedure of DNN Processing>>

### <DNN Processing on Captured Image>

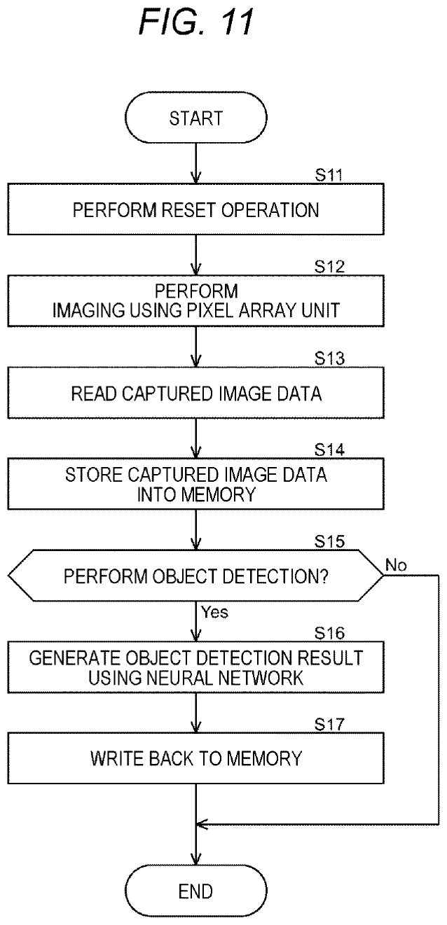

An example procedure of inference processing and training processing in a case where object detection is performed using inference processing on a captured image with an inference model will be described as DNN processing on the captured image. Note that FIGS. 11 to 22 given below will be described on the basis of the imaging device 2 with the configuration illustrated in FIG. 8, but it is assumed that the processing in the signal processing circuit 105 illustrated in FIG. 8 is performed by the DNN processing circuit 126 illustrated in FIG. 10.

### Example Procedure of Inference Processing

FIG. 11 is a flowchart illustrating an example procedure of inference processing of an inference model that performs object detection using a captured image as input. In step S11, reset operations for each unit of the imaging device 2 are performed. In step S12, the pixel array unit 101 performs imaging. In step S13, the DNN processing circuit 126 reads a captured image (data) from the pixel array unit 101. In step S14, the DNN processing circuit 126 stores the read captured image into the memory 106. In step S15, the DNN processing circuit 126 determines whether or not to perform object detection. In a case where a positive determination is made in step S15, the processing proceeds to step S16. In a case where a negative determination is made in step S15, the processing ends. In step S16, the DNN processing circuit 126 retrieves the captured image from the memory 106, inputs the captured image into the inference model (neural network) to perform object detection using inference processing with the inference model, and outputs the object detection result as output of the inference model. In step S17, the DNN processing circuit 126 writes the object detection result back to the memory 106. Once step S17 is completed, this flowchart's processing ends.

### Example Procedure of Training Processing

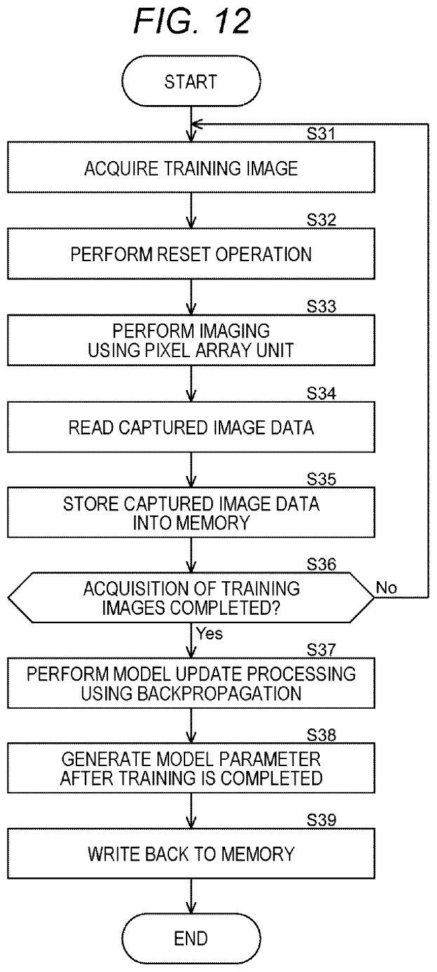

FIG. 12 is a flowchart illustrating an example procedure of training processing of an inference model using a captured image as input. In step S31, the DNN processing circuit 126 starts processing of acquiring training images. In step S32, reset operations for each unit of the imaging device 2 are performed. In step S33, the pixel array unit 101 performs imaging. In step 834, the DNN processing circuit 126 reads a captured image (data) from the pixel array unit 101. In step S35, the DNN processing circuit 126 stores the read captured image into the memory 106. In step S36, the DNN processing circuit 126 determines whether or not the acquisition of training images has been completed. That is, the DNN processing circuit 126 determines whether or not the number of captured images necessary for the training processing of the inference model has been acquired. In a case where a positive determination is made in step S36, the processing proceeds to step S37. In a case where a negative determination is made in step S36, the processing returns to step S31 and is repeated from step S31. In step S37, the DNN processing circuit 126 performs model update processing using the training images and backpropagation. In step S38, the DNN processing circuit 126 generates model parameters after the training is completed. In step S39, the DNN processing circuit 126 writes the generated model parameters back to the memory 106. Once step S39 is completed, this flowchart's processing ends.

### <DNN Processing on Internal Element Characteristic>

An example procedure of inference processing and training processing in a case where a circuit configuration value (element control parameter) is fed back using inference processing on an internal element characteristic with an inference model will be described as DNN processing on the internal element characteristic.

### Example of Input/Output Data of Inference Processing

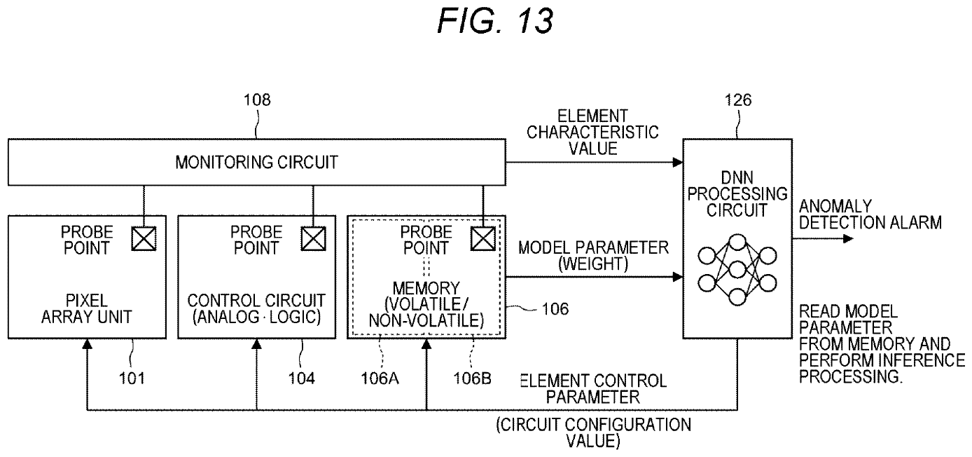

FIG. 13 is a diagram for describing input/output data of an inference model that feeds back a circuit configuration value using an internal element characteristic as input. In the imaging device 2 illustrated in FIG. 13, the pixel array unit 101, the control circuit 104, the memory 106, the monitoring circuit 108, and the DNN processing circuit 126 illustrated in FIGS. 8 and 10 are illustrated. The DNN processing circuit 126 reads model parameters from the memory 106 and configures (builds) an inference model. The monitoring circuit 108 detects an element characteristic value from each of the probe points of the pixel array unit 101, the control circuit 104, and the memory 106, and supplies the element characteristic value to the DNN processing circuit 126. The DNN processing circuit 126 uses the element characteristic value received from the monitoring circuit 108 as input for the inference model. The DNN processing circuit 126 supplies a circuit configuration value (control parameter) output. as the inference result of the inference model to the pixel array unit 101, the control circuit 104, and the memory 106. The pixel array unit 101, the control circuit 104, and the memory 106 operate in accordance with the circuit configuration value received from the DNN processing circuit 126. Note that the memory 106 can be configured as a single memory or can be configured as two separate memories: a control value storage memory 106A and a compensation target memory 106B. The control value storage memory 106A is a memory that stores data for controlling model parameters, circuit configuration values, and the like. The compensation target memory 106B is a memory that stores data other than the model parameters and the like, such as image data. The compensation target memory 106B is subject to compensation based on the circuit configuration value of the inference result of the DNN processing circuit 126 in a case where normal data reading becomes impossible due to aging, failure, or the like. In addition, the memory 106 can be configured as a single memory partitioned into areas serving as the control value storage memory 106A and the compensation target memory 106B.

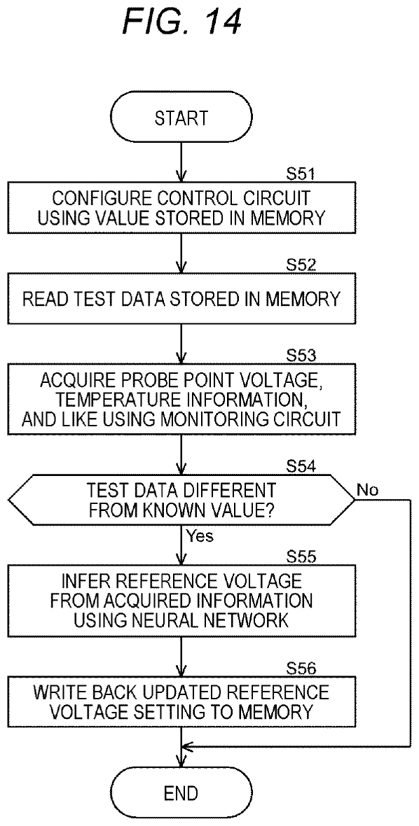

In an example of the processing procedure of the inference processing illustrated in the following FIG. 14, the inference model is assumed to output a bias voltage (reference voltage) for a sense amplifier used for memory reading as a circuit configuration value of the inference result.

### Example Procedure of Inference Processing

FIG. 14 is a flowchart illustrating an example procedure of inference processing of an inference model that outputs the circuit configuration value using an internal element characteristic as input. In step S51, the control circuit 104 is configured (set) using the values stored in the memory 106 (control value storage memory 106A). In step S52, the control circuit 104 reads known test data stored in memory 106 (compensation target memory 106B). In step S53, the monitoring circuit 108 acquires a probe point voltage, temperature information, and the like as an element characteristic value. Here, steps S52 and S53 can be performed in parallel while maintaining synchronization. In step S54, the control circuit 104 determines whether or not the test data read from the memory 106 (compensation target memory 106B) is different from a known value. In a case where it is determined in step S54 that the test data is not different from the known value, the processing ends. In a case where it is determined in step S54 that the test data is different from the known value, the processing proceeds to step S55. In step S55, the DNN processing circuit 126 inputs the element characteristic value acquired by the monitoring circuit 108 into the inference model to cause the inference model to infer a reference voltage (reference voltage for the read circuit of the compensation target memory 106B) or the like as a circuit configuration value. In step S55, the DNN processing circuit 126 writes back the reference voltage value inferred by the inference model to the memory 106 (control value storage memory 106A) to update the reference voltage value to be used by the control circuit 104 as the next circuit configuration value. Once step S55 is completed, this flowchart's processing ends.

### Example of Input/Output Data of Training Processing

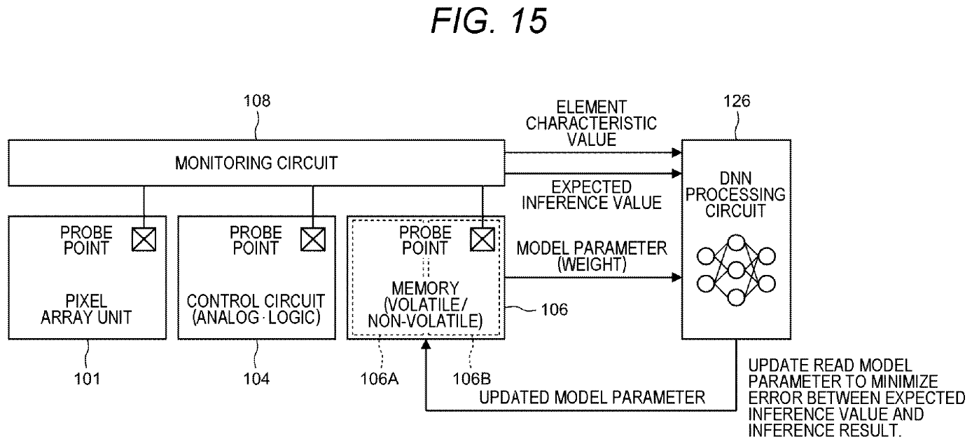

FIG. 15 is a diagram for describing input/output data during training of an inference model that feeds back a circuit configuration value using an internal element characteristic as input. Note that, in the drawing, parts common to FIG. 13 are denoted by the same reference numerals, and their descriptions will be omitted. The DNN processing circuit 126 reads model parameters from the memory 106 and configures (builds) an inference model. The monitoring circuit 108 detects an element characteristic value from each of the probe points of the pixel array unit 101, the control circuit 104, and the memory 106, and supplies the element characteristic value along with an expected inference value to the DNN processing circuit 126. The expected inference value is ground truth data for the output of the inference model corresponding to the element characteristic value detected from each probe point and input into the inference model, and expected inference values corresponding to element characteristic values are prepared in advance. The DNN processing circuit 126 updates the model parameters using the element characteristic values received from the monitoring circuit 108 and the expected inference values as training data. After the training, the DNN processing circuit 126 writes the updated model parameters back to the memory 106, and the inference model is configured using the model parameters in the inference processing from the next time onward.

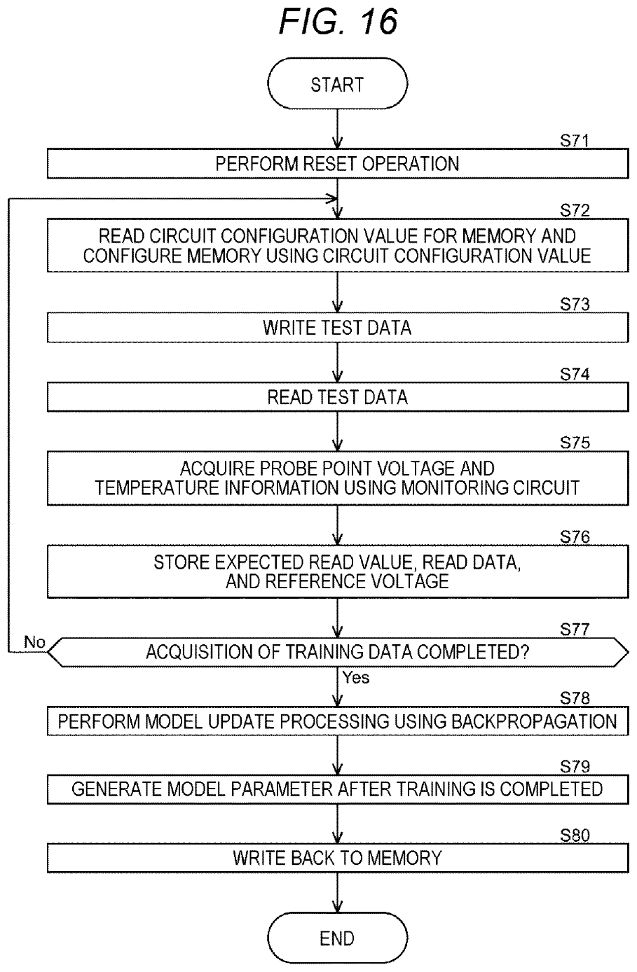

In an example of the processing procedure of the training processing illustrated in the following FIG. 16, the inference model is assumed to learn (detect) changes in memory reading characteristics due to aging and output a circuit configuration value such as a bias voltage (reference voltage) for the sense amplifier used for memory reading as an inference result.

### Example Procedure of Training Processing

FIG. 16 is a flowchart illustrating an example procedure of training processing of training an inference model using an internal element characteristic as input. In step 871, reset operations for each unit of the imaging device 2 are performed. In step S72, the control circuit 104 reads a circuit configuration value from the memory 106 (control value storage memory 106A), and performs configuration (setting) of the memory 106 (compensation target memory 106B) using the circuit configuration value. In step S73, the DNN processing circuit 126 writes known test data to the memory 106 (compensation target memory 106B). In step S74, the DNN processing circuit 126 reads the test data written to the memory 106 (compensation target memory 106B). In step S75, the monitoring circuit 108 acquires a probe point voltage (including a reference voltage and the like), temperature information, and the like as an element characteristic value. Here, steps S74 and S75 can be performed in parallel while maintaining synchronization. In step S76, the DNN processing circuit 126 stores an expected read value of test data (test data in step S73), the read test data (test data in step S74), and the element characteristic value such as a reference voltage (element characteristic value acquired in step S75) into the memory 106 (the control value storage memory 106A) as training data.

In step S77, the DNN processing circuit 126 determines whether or not to terminate the acquisition of training data. In a case where a positive determination is made in step S77, the processing proceeds to step S78. In a case where a negative determination is made in step S77, the processing returns to step S72 and is repeated from step S72. In step S78, the DNN processing circuit 126 performs, using the training data, model update processing using backpropagation. That is, for example, in preparation for a case where the characteristics of the memory 106 (compensation target memory 106B) change due to aging or the like and the data stored in the memory 106 (compensation target memory 106B) cannot be correctly read, training of the model parameters to minimize an error in the reference voltage output from the inference model using the known test data and the element characteristic value received from the monitoring circuit 108 is performed to enable the inference model to infer a reference voltage that enables correct reading of the test data. In step S79, the DNN processing circuit 126 generates model parameters after the training is completed. In step S80, the DNN processing circuit 126 writes the generated model parameters back to the memory 106 (control value storage memory 106A). Once step S80 is completed, this flowchart's processing ends.

### <DNN Processing on Captured Image and Internal Element Characteristic>

An example procedure of inference processing and training processing in a case where object detection is performed using inference processing on a captured image and an internal element characteristic with an inference model will be described as DNN processing on the captured image and the internal element characteristic.

### Example of Input/Output Data of Inference Processing

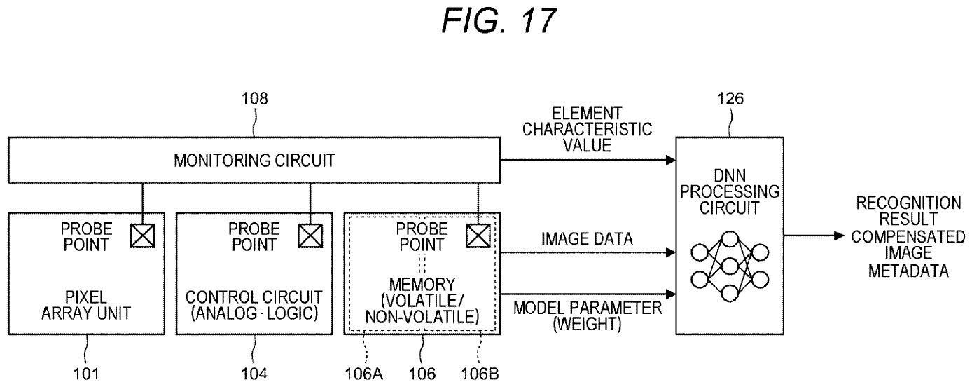

FIG. 17 is a diagram for describing input/output data of an inference model that performs object detection using a captured image and an internal element characteristic as input. Note that, in the drawing, parts common to FIG. 15 are denoted by the same reference numerals, and their descriptions will be omitted. The DNN processing circuit 126 reads model parameters from the memory 106 and configures (builds) an inference model. The monitoring circuit 108 detects an element characteristic value from each of the probe points of the pixel array unit 101, the control circuit 104, and the memory 106, and supplies the element characteristic value to the DNN processing circuit 126. The memory 106 supplies a captured image captured by the pixel array unit 101 and stored in the memory 106 to the DNN processing circuit 126. The DNN processing circuit 126 uses the element characteristic value received from the monitoring circuit 108 and the captured image received from the memory 106 as input for the inference model. The DNN processing circuit 126 outputs a recognition result, metadata, or a compensated image output as the inference result of the inference model to the external system or the like.

### Example Procedure of Inference Processing

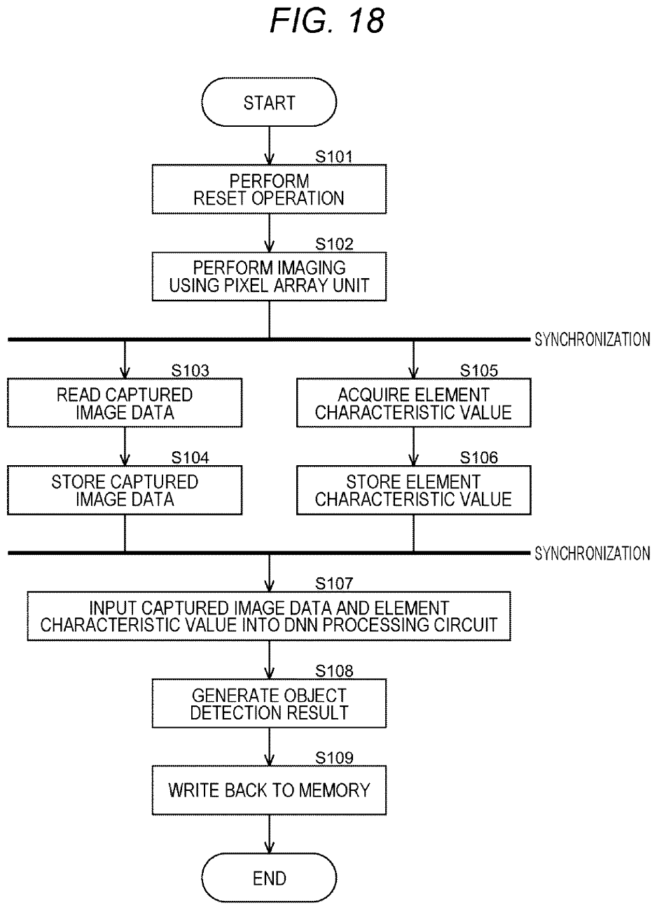

FIG. 18 is a flowchart illustrating an example procedure of inference processing of an inference model that performs object detection using a captured image and an internal element characteristic as input. In step S101, reset operations for each unit of the imaging device 2 are performed. In step S102, the pixel array unit 101 performs imaging. In step S103, the DNN processing circuit 126 reads a captured image (data) from the pixel array unit 101. In step S104, the DNN processing circuit 126 stores the read captured image into the memory 106. In step S105, the monitoring circuit 108 acquires a probe point voltage, temperature information, and the like as an element characteristic value. In step S106, the monitoring circuit 108 stores the acquired element characteristic value into the memory 106. Note that steps S103 and S105 are initiated simultaneously, and when both steps S104 and S106 are completed, the processing proceeds to step S107.

In step S107, the DNN processing circuit 126 acquires the captured image and the element characteristic value from the memory 106, and inputs the captured image and the element characteristic value into the inference model (neural network). In step S108, the DNN processing circuit 126 performs object detection using inference processing with the inference model, and outputs the object detection result as output of the inference model. In step S109, the DNN processing circuit 126 writes the object detection result back to the memory 106. Once step S109 is completed, this flowchart's processing ends.

### Example of Input/Output Data of Training Processing

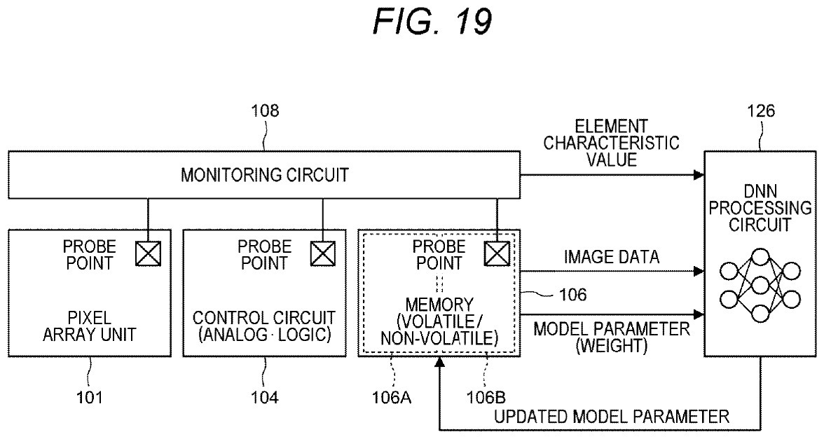

FIG. 19 is a diagram for describing input/output data during training of an inference model that performs image recognition (not limited to object detection) using a captured image and an internal element characteristic as input. Note that, in the drawing, parts common to FIG. 15 are denoted by the same reference numerals, and their descriptions will be omitted. The DNN processing circuit 126 reads model parameters from the memory 106 and configures (builds) an inference model. The monitoring circuit 108 detects an element characteristic value from each of the probe points of the pixel array unit 101, the control circuit 104, and the memory 106, and supplies the element characteristic value to the DNN processing circuit 126. The memory 106 supplies a captured image captured by the pixel array unit 101 and stored in the memory 106 to the DNN processing circuit 126. The DNN processing circuit 126 performs unsupervised learning for the inference model using the element characteristic value received from the monitoring circuit 108 and the captured image received from the memory 106 as training data. After the training, the DNN processing circuit 126 writes the updated model parameters back to the memory 106, and the inference model is configured using the model parameters in the inference processing from the next time onward.

### Example Procedure of Training Processing

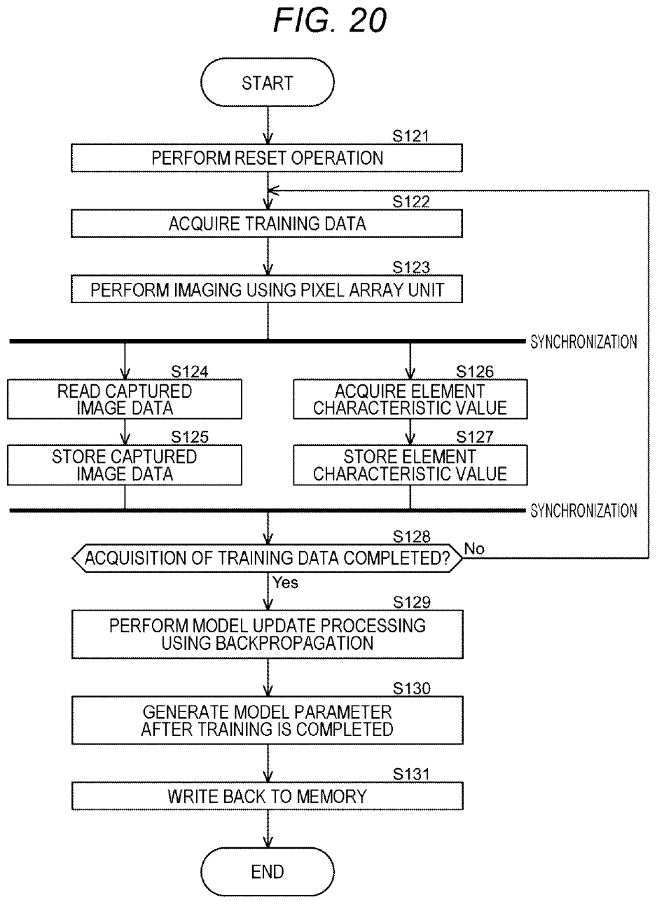

FIG. 20 is a flowchart illustrating an example procedure of training processing of an inference model that performs image recognition using a captured image and an internal element characteristic as input. In step S121, reset operations for each unit of the imaging device 2 are performed. In step S122, the DNN processing circuit 126 starts to acquire training data. In step S123, the pixel array unit 101 performs imaging. In step S124, the DNN processing circuit 126 reads a captured image (data) from the pixel array unit 101. In step S125, the DNN processing circuit 126 stores the read captured image into the memory 106. In step S126, the monitoring circuit 108 acquires a probe point voltage, temperature information, and the like as an element characteristic value. In step S127, the monitoring circuit 108 stores the acquired element characteristic value into the memory 106. Note that steps S124 and S126 are initiated simultaneously, and when both steps S125 and S127 are completed, the processing proceeds to step S128.

In step S128, the DNN processing circuit 126 determines whether or not the acquisition of training data has been completed. In a case where a positive determination is made in step S128, the processing proceeds to step S129. In a case where a negative determination is made in step S128, the processing returns to step S122 and is repeated from step S122. In step s129, the DNN processing circuit 126 retrieves the captured image and the element characteristic value from the memory 106 and inputs the captured image and the element characteristic value into the inference model (neural network) to perform model update processing using backpropagation. In step S130, the DNN processing circuit 126 generates model parameters after the training is completed. In step S131, the DNN processing circuit 126 writes the generated model parameters back to the memory 106 (control value storage memory 106A).

Once step S131 is completed, this flowchart's processing ends.

### Execution of Training Processing

### (Embodiment 1)

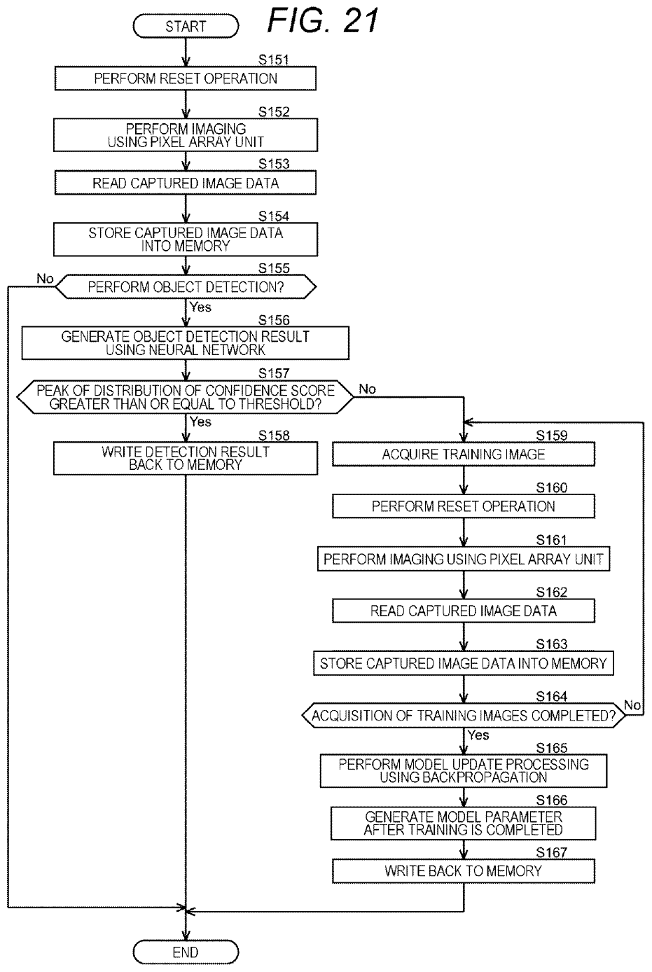

FIG. 21 is a flowchart illustrating an example procedure of processing of determining training timing from an inference result of inference processing of detecting an object in a captured image. Note that steps S151 to S156 in FIG. 21 are the same as steps S11 to S16 in FIG. 11, and steps S159 to S167 in FIG. 21 are the Same as steps S31 to S39 in FIG. 12, and thus their descriptions will be omitted. Note that in a case where the memory 106 is partitioned into the control value storage memory 106A and the compensation target memory 106B, the model parameters are written back to the control value storage memory 106A in step S167. In step S157, the DNN processing circuit 126 determines whether or not the object detection result or the peak of confidence score distribution output from the inference model is greater than or equal to a threshold. In a case where a positive determination is made in step S157, the processing proceeds to step S158. In a case where a negative determination is made in step S157, the processing proceeds to step S159. In step S158, the DNN processing circuit 126 writes the object detection result back to the memory 106. Once step S158 is completed, this flowchart's processing ends. In steps S159 to S167, the training processing of the inference model is performed, and once the training is completed, this flowchart's processing ends.

### (Embodiment 2)

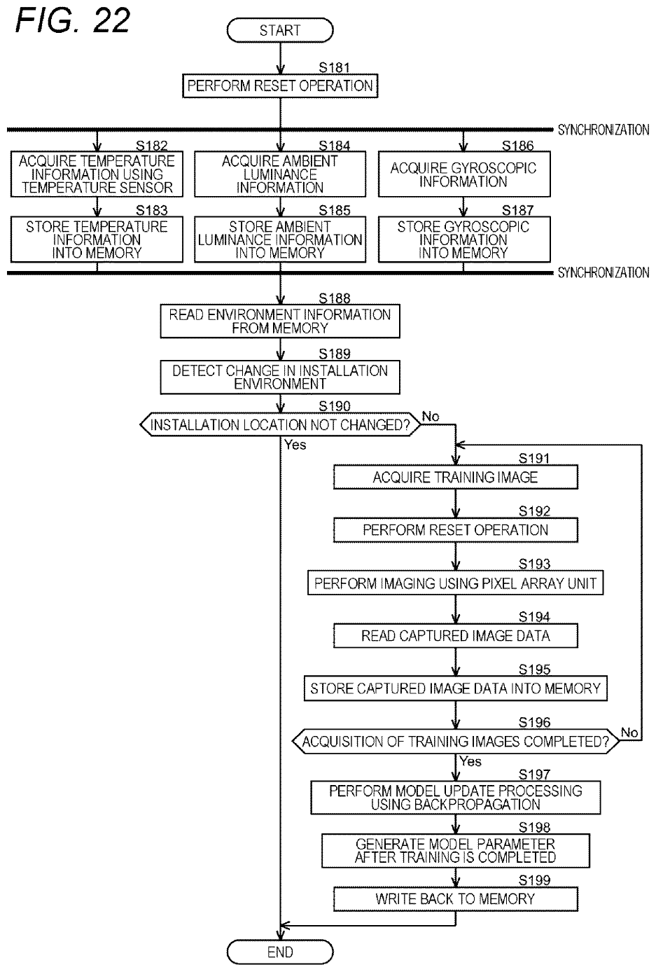

FIG. 22 is a diagram illustrating an example procedure of processing of determining training timing by detecting a change in installation environment (arrangement environment). Note that steps S191 to S199 in FIG. 22 are the same as steps S31 to S39 in FIG. 12, and thus their descriptions will be omitted. In step S181, reset operations for each unit of the imaging device 2 are performed. In step S182, the DNN processing circuit 126 acquires temperature information from a temperature sensor located outside the imaging device 2. In step S183, the DNN processing circuit 126 stores the acquired temperature information into the memory 106 (control value storage memory 106A). In step S184, the DNN processing circuit 126 acquires ambient luminance information from an illuminance sensor located outside the imaging device 2. The ambient luminance information may be acquired from a captured image. In step S185, the DNN processing circuit 126 stores the acquired luminance information into the memory 106 (control value storage memory 106A). In step S186, the DNN processing circuit 126 acquires gyroscopic information from a gyroscopic sensor located outside the imaging device 2. In step S187, the DNN processing circuit 126 stores the acquired gyroscopic information into the memory 106 (control value storage memory 106A). Note that steps S182, S184, and S186 are initiated simultaneously, and when steps S183, S185, and S187 are all completed, the processing proceeds to step S188.

In step S188, the DNN processing circuit 126 reads the environment information (temperature information, luminance information, gyroscopic information) from the memory 106 (control value storage memory 106A). In step S189, the DNN processing circuit 126 detects a change in installation environment (arrangement environment) of the imaging device 2 on the basis of the environment information. In step S190, the DNN processing circuit 126 determines whether or not the installation location of the imaging device 2 has been changed. In a case where a positive determination is made in step S190, this flowchart's processing ends. In a case where a negative determination is made in step S190, the processing proceeds to step S191, in steps S191 to S199, the training processing of the inference model is performed, and once the training is completed, this flowchart's processing ends. Note that in a case where the memory 106 is partitioned into the control value storage memory 106A and the compensation target memory 106B, the model parameters are written back to the control value storage memory 106A in step S199.

### <Configuration Example of Computer>

The above-described series of processing can be performed by hardware or software. In a case where the series of processing is performed by software, a program that makes up the software is installed in a computer. Here, examples of the computer include a computer incorporated in dedicated hardware, and for example, a general-purpose personal computer that can execute various functions by installation of various programs.

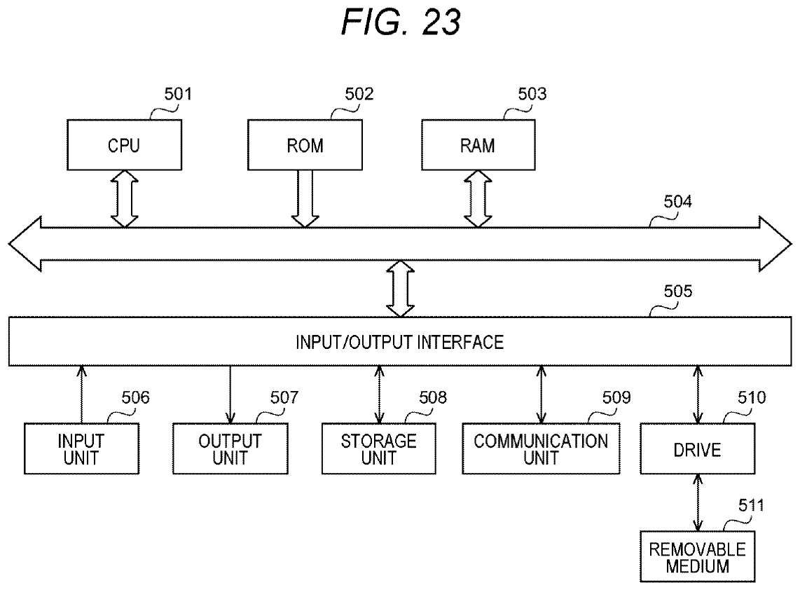

FIG. 23 is a block diagram illustrating a configuration example of hardware of a computer that performs the above-described series of processing by a program.

In the computer, a central processing unit (CPU) 501, a read only memory (ROM) 502, and a random access memory (RAM) 503 are mutually connected by a bus 504.

An input/output interface 505 is further connected to the bus 504. To the input/output interface 505, an input unit 506, an output unit 507, a storage unit 508, a communication unit 509, and a drive 510 are connected.

The input unit 506 includes a keyboard, a mouse, a microphone, and the like. The output unit 507 includes a display, a speaker, and the like. The storage unit 508 includes a hard disk, a non-volatile memory, and the like. The communication unit 509 includes a network interface and the like. The drive 510 drives a removable medium 511 such as a magnetic disk, an optical disc, a magnetooptical disk, or a semiconductor memory.

In the computer configured as described above, for example, the CPU 501 loads the program stored in the storage unit 508 into the RAM 503 via the input/output interface 505 and the bus 504 and executes the program, whereby the above-described series of processing is performed.

The program executed by the computer (CPU 501) can be provided by being recorded on, for example, the removable medium 511 as a package medium or the like.

Furthermore, the program can be provided via a wired or wireless transmission medium such as a local area network, the Internet, or digital satellite broadcasting.

In the computer, the removable medium 511 is mounted to the drive 510, whereby the program can be installed in the storage unit 508 via the input/output interface 505. Furthermore, the program can be received by the communication unit 509 via the wired or wireless transmission medium to be installed on the storage unit 508. Other than the above, the programs can be installed into the ROM 502 or the storage unit 508 in advance.

Note that the program to be executed by the computer may be a program that performs processing in time-series order described in the present specification, or may be a program that performs processing in parallel or at necessary timing such as when a call is made.

Here, in the present specification, the processing to be performed by the computer in accordance with a program is not necessarily performed in time series order illustrated in the flowchart. In other words, the processing to be performed by the computer in accordance with the program include processing to be performed in parallel or independently (for example, parallel processing or object-based processing).

Furthermore, the program may correspond to processing to be performed by a single computer (processor) or processing to be performed in a distributed manner by a plurality of computers.

Moreover, the program may be transferred to a distant computer to be executed.

Moreover, in the present description, a system means a set of a plurality of configuration elements (devices, modules (parts), and the like), and it does not matter whether or not all the configuration elements are in the same housing. Therefore, a plurality of devices housed in separate housings and connected to each other via a network and a single device in which a plurality of modules is housed in one housing are both systems.

Furthermore, for example, a configuration described as one device (or processing unit) may be divided and configured as the plurality of devices (or processing units). Conversely, the configurations described above as a plurality of devices (or processing units) may be collectively configured as a single device (or processing unit). Furthermore, it goes without saying that a configuration other than the above-described configurations may be added to the configuration of each device (or each processing unit). Moreover, as long as the configuration and operation of the entire system are substantially the same, a part of the configuration of a certain device (or processing unit) may be included in the configuration of another device (or another processing unit).

Furthermore, for example, the present technology can be configured as cloud computing in which a plurality of devices shares a single function and jointly performs processing over a network.

Furthermore, for example, the program described above can be executed by any device. In this case, the device is only required to have a necessary function (functional block or the like) and obtain necessary information.

Furthermore, for example, each step described in the flowcharts described above can be performed by one device, or can be performed in a shared manner by the plurality of the devices. Moreover, in a case where a single step includes a plurality of processes, the plurality of processes included in the single step can be performed by a single device or performed by a plurality of devices in a shared manner. In other words, the plurality of processes included in the single step can also be performed as a plurality of steps. Conversely, the processes described as the plurality of the steps can also be collectively performed as one step.

Note that, in the program to be executed by the computer, the processes of steps describing the program may be performed in time-series order described in the present specification, or may be performed in parallel, or independently at necessary timing such as when a call is made. That is, as long as there is no contradiction, the process of each step may be performed in a different order from the above-described order. Moreover, the processes of the steps describing the program may be performed in parallel with processes of the other program, or may be performed in combination with the processes of the other program.

Note that, the plurality of present technologies that has been described in the present specification can each be implemented independently as a single unit unless there is a contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

### Combination Example of Configurations

Note that the present technology may also provide the following configurations.

(1)

An imaging device including:
an imaging unit that captures an image; and
a processing unit integrated into a chip along with the imaging unit, the processing unit being configured to perform inference processing using a captured image captured by the imaging unit as input, in which
the processing unit performs training processing of an inference model used in the inference processing.
   (2)

The imaging device according to the above (1), in which
the inference model has a structure of a neural network in machine learning technology.
   (3)

The imaging device according to the above (1) or (2), in which
the processing unit performs the training processing using the captured image captured by the imaging unit.
   (4)

The imaging device according to any one of the above (1) to (3), in which
the processing unit performs the training processing using backpropagation.
   (5)

The imaging device according to any one of the above (1) to (4), in which
the processing unit determines training timing at which the training processing is performed.
   (6)

The imaging device according to the above (5), in which
the processing unit determines the training timing on the basis of confidence scores of each class output by the inference processing on the basis of environment information.
   (7)

The imaging device according to the above (5) or (6), in which
the processing unit determines the training timing on the basis of an element characteristic value indicating a characteristic of an element integrated into the chip.
   (8)

The imaging device according to the above (7), in which
the processing unit determines the training timing on the basis of a change in the element characteristic value.
   (9)

The imaging device according to any one of the above (1) to (8), in which
the processing unit performs image recognition on the captured image using the inference processing.
   (10)

An imaging device including:
an imaging unit that captures an image; and
a processing unit that performs inference processing, in which
the processing unit performs the inference processing using an element characteristic value indicating a characteristic of an element as input.
   (11)

The imaging device according to the above (10), in which
the processing unit outputs a circuit configuration value related to operation of a circuit as an inference result of the inference processing.
   (12)

The imaging device according to the above (10) or (11), in which
the processing unit acquires, as the element characteristic value, an element characteristic value of any one of a pixel array, a control circuit, or a storage element of the imaging unit.
   (13) The imaging device according to any one of the above (10) to (12), in which
the processing unit acquires any one of a current value, a voltage value, or temperature information as the element characteristic value.
   (14)

The imaging device according to any one of the above (10) to (13), in which
the processing unit performs the inference processing using a captured image captured by the imaging unit and the element characteristic value as input.
   (15)

The imaging device according to the above (14), in which
the processing unit performs image recognition on the captured image using the inference processing.
   (16)

The imaging device according to any one of the above (10) to (15), in which
the processing unit performs training processing of an inference model used in the inference processing.
   (17)

The imaging device according to any one of the above (10) to (16), in which
the imaging unit and the processing unit are integrated into a chip.
   (18)

A data processing method including:
causing an imaging unit of a data processing device to capture an image, the data processing device including the imaging unit and a processing unit integrated into a chip along with the imaging unit; and
causing the processing unit to perform inference processing using a captured image captured by the imaging unit as input and perform training processing of an inference model used in the inference processing.
   (19)

A recording medium recording a program, the program causing a computer to function as:
a processing unit integrated into a chip along with an imaging unit that captures an image, the processing unit being configured to perform inference processing using a captured image captured by the imaging unit as input and perform training processing of an inference model used in the inference processing.

### REFERENCE SIGNS LIST

1 Imaging device
101 Pixel array unit
104 Control circuit
105 Signal processing circuit
108 Memory
126 DNN circuit

1. An imaging device comprising:
an imaging unit that captures an image; and
a processing unit integrated into a chip along with the imaging unit, the processing unit being configured to perform inference processing using a captured image captured by the imaging unit as input, wherein
the processing unit performs training processing of an inference model used in the inference processing.

2. The imaging device according to claim 1, wherein
the inference model has a structure of a neural network in machine learning technology.

3. The imaging device according to claim 1, wherein
the processing unit performs the training processing using the captured image captured by the imaging unit.

4. The imaging device according to claim 1, wherein
the processing unit performs the training processing using backpropagation.

5. The imaging device according to claim 1, wherein
the processing unit determines training timing at which the training processing is performed.

6. The imaging device according to claim 5, wherein
the processing unit determines the training timing on a basis of confidence scores of each class output by the inference processing on a basis of environment information.

7. The imaging device according to claim 5, wherein
the processing unit determines the training timing on a basis of an element characteristic value indicating a characteristic of an element integrated into the chip.

8. The imaging device according to claim 7, wherein
the processing unit determines the training timing on a basis of a change in the element characteristic value.

9. The imaging device according to claim 1, wherein
the processing unit performs image recognition on the captured image using the inference processing.

10. An imaging device comprising:
an imaging unit that captures an image; and
a processing unit that performs inference processing, wherein
the processing unit performs the inference processing using an element characteristic value indicating a characteristic of an element as input.

11. The imaging device according to claim 10, wherein
the processing unit outputs a circuit configuration value related to operation of a circuit as an inference result of the inference processing.

12. The imaging device according to claim 10, wherein
the processing unit acquires, as the element characteristic value, an element characteristic value of any one of a pixel array, a control circuit, or a storage element of the imaging unit.

13. The imaging device according to claim 10, wherein
the processing unit acquires any one of a current value, a voltage value, or temperature information as the element characteristic value.

14. The imaging device according to claim 10, wherein
the processing unit performs the inference processing using a captured image captured by the imaging unit and the element characteristic value as input.

15. The imaging device according to claim 14, wherein
the processing unit performs image recognition on the captured image using the inference processing.

16. The imaging device according to claim 10, wherein
the processing unit performs training processing of an inference model used in the inference processing.

17. The imaging device according to claim 10, wherein
the imaging unit and the processing unit are integrated into a chip.

18. A data processing method comprising:
causing an imaging unit of a data processing device to capture an image, the data processing device including the imaging unit and a processing unit integrated into a chip along with the imaging unit; and
causing the processing unit to perform inference processing using a captured image captured by the imaging unit as input and perform training processing of an inference model used in the inference processing.

19. A recording medium recording a program, the program causing a computer to function as:
a processing unit integrated into a chip along with an imaging unit that captures an image, the processing unit being configured to perform inference processing using a captured image captured by the imaging unit as input and perform training processing of an inference model used in the inference processing.
